(19) United States
(12) Patent Application Publication
(10) Pub. No.: US 2026/0331807 A1
(43) Pub. Date: Oct. 22, 2026

(54) ELECTRONIC ASSEMBLY HAVING A PLUG CONNECTOR

(71) Applicant: TE Connectivity Solutions GmbH, Schaffhausen (CH)

(72) Inventors: Craig Warren Hornung, Middletown, PA (US); Matthew Jeffrey Sypolt, Middletown, PA (US); Chad William Morgan, Middletown, PA (US)

(21) Appl. No.: 19/202,074

(22) Filed: May 8, 2025

Related U.S. Application Data
(60) Provisional application No. 63/790,526, filed on Apr. 17, 2025.

(51) Int. Cl. H01R 12/79; H01R 13/04; H01R 13/508; H01R 13/629; H01R 13/652; H01R 13/6581

(52) U.S. Cl. CPC H01R 12/79; H01R 13/652; H01R 13/6581; H01R 13/04; H01R 13/508; H01R 13/629

(57) ABSTRACT

A plug connector for mating with a electrical connector includes cable termination modules each having a contact module having contacts and cables terminated to terminating ends of the corresponding contacts. Each cable termination module includes a ground cage that provides circumferential shielding around an end of the cable and around the corresponding contact module having a connecting leg at a mating end of the ground cage. The plug connector includes a ground block with pockets to receive the corresponding cable termination modules and slots proximate to the pockets that receive the connecting legs of the ground cages of the cable termination modules. The connecting legs are electrically connected to the ground block in the corresponding slots.

### CROSS REFERENCE TO RELATED APPLICATIONS

This application claims benefit to U.S. Application No. 63/790,526, filed on 17 Apr. 2025, entitled “CABLE TERMINATION MODULE FOR A PLUG CONNECTOR”, the subject matter of which is herein incorporated by reference in its entirety. The subject matter herein relates generally to communication systems.

### BACKGROUND OF THE INVENTION

The subject matter herein relates generally to communication systems.

There is an ongoing trend toward smaller, lighter, and higher performance communication components and higher density systems, such as for ethernet switches or other system components. Typically, the system includes an electronic package coupled to a circuit board, such as through a socket connector. Electrical signals are routed between the electronic package and the circuit board. The electrical signals are then routed along traces on the circuit board to another component, such as a transceiver connector. The long electrical paths through the host circuit board reduce electrical performance of the system. Additionally, losses are experienced between the connector interfaces and along the electrical signal paths of the transceivers. Conventional systems are struggling with meeting signal and power output from the electronic package.

Some known systems utilize an electronic assembly having cable assemblies to transmit the signals along cables rather than signal traces along the host circuit board. However, the electronic assembly includes numerous cables terminated to a circuit card. There are limits to spacing of the contact pads to allow routing of the cables from the circuit card with conventional cable termination techniques. For example, ample spacing is needed between rows of the circuit cards to allow routing of the cables along the circuit card. Additionally, as data speeds increase, the shielding (for example, return path) along the signal paths, particularly at the numerous interfaces, is proving ineffective, particularly at higher frequencies.

### BRIEF DESCRIPTION OF THE INVENTION

In an embodiment, a plug connector for mating with a electrical connector is provided. The plug connector includes cable termination modules. Each cable termination module includes a contact module having contacts extending between connecting ends configured to be mated with mating contacts of the electrical connector and terminating ends opposite the connecting ends. Each cable termination module includes cables having signal conductors terminated to the terminating ends of the corresponding contacts and a cable shield surrounding the signal conductors. Each cable termination module includes a ground cage that provides circumferential shielding around an end of the cable and around the corresponding contact module. The ground cage includes a connecting leg at a mating end of the ground cage. The plug connector includes a ground block that includes pockets to receive the corresponding cable termination modules. The ground block is electrically conductive and provides shielding around the pockets for shielding the cable termination modules. The ground block is electrically connected to the ground cages. The ground block organizes the cable termination modules relative to each other and positions the cable termination modules for mating with the electrical connector. The ground block includes slots proximate to the pockets. The slots receive the connecting legs of the ground cages of the cable termination modules. The connecting legs are electrically connected to the ground block in the corresponding slots.

In another embodiment, a cable termination module for a plug connector configured to be mated with a electrical connector is provided. The cable termination module includes a contact module having contacts extending between connecting ends configured to be mated with mating contacts of the electrical connector and terminating ends opposite the connecting ends. The cable termination module includes a cable having signal conductors terminated to the terminating ends of the corresponding contacts and a cable shield surrounding the signal conductors. The cable termination module includes a ground cage that provides circumferential shielding around an end of the cable and around the corresponding contact module, a mating end of the ground cage configured to be plugged into a pocket of a ground block at a bottom of the plug connector to electrically connect the ground cage to the ground block. The ground cage includes a ferrule, a front cover coupled to the ferrule, and a rear cover coupled to the ferrule. The ferrule includes a base wall, a first side wall extending from a first side of the base wall, and a second side wall extending from a second side of the base wall, the base wall, the first side wall, and the second side wall forming a cradle receives the end of the cable. The first side wall covers a first side of the contact module. The second side wall covers a second side of the contact module. The front cover coupled to the first and second side walls to cover a front side of the contact module. The rear cover coupled to the first and second side walls to cover a rear side of the contact module. The ground cage includes a connecting leg at a mating end of the ground cage configured to be plugged into the ground block to electrically connect the ground cage to the ground block.

In a further embodiment, a communication system is provided and includes a electrical connector that includes a socket frame holding mating contacts. The mating contacts include mating interfaces. The mating contacts include signal contacts and ground contacts. The communication system includes a plug connector configured to be pluggable coupled to the electrical connector. The plug connector includes cable termination modules and a ground block that includes pockets that receive the corresponding cable termination modules. Each cable termination module includes a contact module having contacts extending between connecting ends configured to be mated with the corresponding mating contacts of the electrical connector and terminating ends opposite the connecting ends. Each cable termination module includes cables having signal conductors terminated to the terminating ends of the corresponding contacts and a cable shield surrounding the signal conductors. Each cable termination module includes a ground cage that provides circumferential shielding around an end of the cable and around the corresponding contact module. The ground cage includes a connecting leg at a mating end of the ground cage. The ground block is electrically conductive and provides shielding around the pockets for shielding the cable termination modules. The ground block is electrically connected to the ground cages. The ground block organizes the cable termination modules relative to each other and positions the cable termination modules for mating with the electrical connector. The ground block includes slots proximate to the pockets. The slots receive the connecting legs of the ground cages of the cable termination modules. The connecting legs are electrically connected to the ground block in the corresponding slots.

### BRIEF DESCRIPTION OF THE DRAWINGS

FIG. 1 is a perspective view of a communication system having an electronic assembly in accordance with an exemplary embodiment.

FIG. 2 is an exploded view of the communication system in accordance with an exemplary embodiment.

FIG. 3 is a perspective view of the plug connector in accordance with an exemplary embodiment.

FIG. 4 is a perspective view of a portion of the plug connector showing the cable assembly in accordance with an exemplary embodiment.

FIG. 5 is an exploded view of the ground block in accordance with an exemplary embodiment.

FIG. 6 is an assembled, top perspective view of the ground block in accordance with an exemplary embodiment.

FIG. 7 is a bottom view of a portion of one of the ground plates in accordance with an exemplary embodiment.

FIG. 8 is a bottom view of a portion of the bottom ground plate in accordance with an exemplary embodiment.

FIG. 9 is a perspective view of a portion of the contact module in accordance with an exemplary embodiment.

FIG. 10 is a rear perspective view of a portion of the contact module in accordance with an exemplary embodiment.

FIG. 11 is a front perspective view of a portion of the contact module in accordance with an exemplary embodiment.

FIG. 12 illustrates an end of one of the cables in accordance with an exemplary embodiment.

FIG. 13 is a perspective view of the ferrule of the ground cage in accordance with an exemplary embodiment.

FIG. 14 is a perspective view of a portion of the cable termination module showing the ferrule positioned relative to the cable in accordance with an exemplary embodiment.

FIG. 15 is a perspective view of a portion of the cable termination module showing the ferrule positioned relative to the cable in accordance with an exemplary embodiment.

FIG. 16 is a perspective view of a portion of the cable termination module showing the contact module positioned relative to the ferrule and the cable in accordance with an exemplary embodiment.

FIG. 17 is a front perspective view of a portion of the cable termination module showing the front cover coupled to the ferrule in accordance with an exemplary embodiment.

FIG. 18 is a rear perspective view of a portion of the cable termination module showing the front cover coupled to the ferrule in accordance with an exemplary embodiment.

FIG. 19 is a front perspective view of the cable termination module showing the rear cover coupled to the ferrule in accordance with an exemplary embodiment.

FIG. 20 is a rear perspective view of the cable termination module showing the rear cover coupled to the ferrule in accordance with an exemplary embodiment.

FIG. 21 illustrates a portion of the cable assembly showing a plurality of the cable termination modules loaded into the ground block in accordance with an exemplary embodiment.

FIG. 22 illustrates a portion of the cable assembly showing a plurality of the cable termination modules loaded into the ground block in accordance with an exemplary embodiment.

FIG. 23 is a cross-sectional view of a portion of the plug connector showing a plurality of the cable termination modules loaded into the ground block in accordance with an exemplary embodiment.

FIG. 24 is a cross-sectional view of a portion of the plug connector showing one of the cable termination modules loaded into the ground block in accordance with an exemplary embodiment.

FIG. 25 is a bottom perspective view of a portion of the plug connector showing the cable termination modules in the ground block in accordance with an exemplary embodiment.

FIG. 26 is a bottom perceptive view of a portion of the connector housing in accordance with an exemplary embodiment.

FIG. 27 is a bottom perspective view of a portion of the plug connector showing the cable assembly poised for loading into the shell cavity of the outer plug shell in accordance with an exemplary embodiment.

FIG. 28 is a bottom perspective view of a portion of the plug connector showing the cable assembly loaded into the shell cavity of the outer plug shell in accordance with an exemplary embodiment.

FIG. 29 is a front perspective view of a portion of the plug connector showing the cable assembly loaded into the shell cavity of the outer plug shell in accordance with an exemplary embodiment.

FIG. 30 is a rear perspective view of a portion of the plug connector showing the cable assembly loaded into the shell cavity of the outer plug shell in accordance with an exemplary embodiment.

FIG. 31 is a top perspective view of a portion of the plug connector showing the cable assembly and the cable strain relief element coupled to the outer plug shell in accordance with an exemplary embodiment.

FIG. 32 is a perspective view of a group of cable termination modules that are integrated into a common cable termination module in accordance with an exemplary embodiment.

FIG. 33 is a side view of a plurality of the common cable termination modules in accordance with an exemplary embodiment.

FIG. 34 is a perspective view of the cable assembly in accordance with an exemplary embodiment showing a plurality of the common cable termination modules coupled to the ground block.

### DETAILED DESCRIPTION OF THE INVENTION

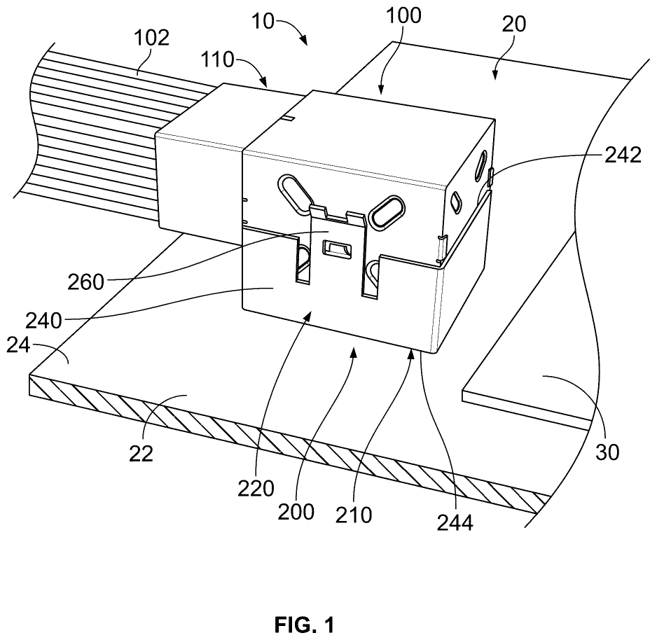

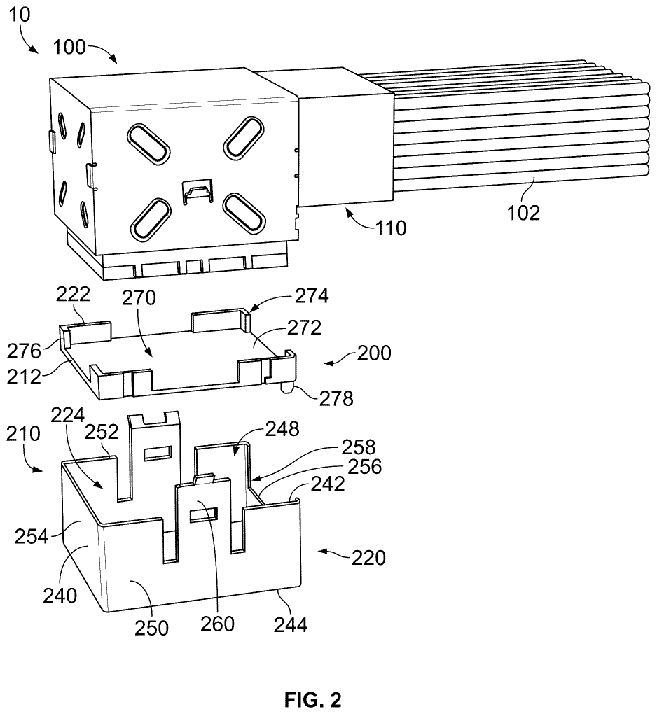

FIG. 1 is a perspective view of a communication system 10 having an electronic assembly 20 in accordance with an exemplary embodiment. FIG. 2 is an exploded view of a portion of the communication system 10 in accordance with an exemplary embodiment. In the illustrated embodiment, the electronic assembly 20 (FIG. 1) includes a circuit board 22 and an electronic package 30 mounted to the circuit board 22. The communication system 10 includes electrical connectors, such as a plug connector 100 and a socket connector 200, being electrically connected to the electronic assembly 20. The mating electrical connector 200 may be another type of electrical connector other than a socket connector in various embodiments, such as a receptacle connector, a header connector, or other type of electrical connector configured to be mated with the plug connector 100. In various embodiments, the socket connector 200 is mounted to the circuit board 22 and used to electrically connect the plug connector 100 to the electronic package 30 of the electronic assembly 20. The plug connector 100 and the socket connector 200 allow high speed signal transmission between components. In various embodiments, the communication system 10 may be used as part of a data center application, high-performance computing application, or other high speed, high density data communication applications. The plug connector 100 and the socket connector 200 may be used for data communication between GPU and CPU chip devices or other communication components. The plug connector 100 is designed to provide improved signal integrity, better impedance control, enhanced EMI shielding, high density, efficient high-frequency performance, reduced crosstalk, and improved reliability compared to conventional plug connectors.

In an exemplary embodiment, the plug connector 100 is a cable connector provided at ends of cables 102. The plug connector 100 is configured to be coupled to the socket connector 200 at a separable mating interface, such as a land grid array (LGA) interface, a spring beam array interface, conductive elastomeric connector interface, or other type of separable connector interface. A mating end of the plug connector 100 is configured to be plugged into the socket connector 200 to mate with the array of mating contacts of the socket connector 200. In an exemplary embodiment, the plug connector 100 includes a cable assembly 110 configured to be mated with the socket connector 200. In an exemplary embodiment, the plug connector 100 utilizes individually terminated differential pairs of high-speed signal transmission lines. The pairs can be configured as single units or modularized, such as into 1×4 or 1×8 arrangements offering scalability and adaptability to various connection requirements. The pairs may be tightly arranged within the plug connector 100 for ultra-high density within the form factor of the plug connector 100 and socket connector 200 to meet increasing demands for miniaturization in electronic devices.

In an exemplary embodiment, the socket connector 200 is a board connector mounted to a circuit board 22 of the electronic assembly 20. The socket connector 200 may be a receptacle connector or a header connector. In an exemplary embodiment, the socket connector 200 is mounted to the circuit board 22. For example, the socket connector 200 may include a ball grid array (BGA) interface, LGA interface, a spring beam array interface, a conductive elastomeric connector interface, or other type of connector interface. The plug connector 100 is configured to be plugged into a socket 212 of the socket connector 200. The socket connector 200 is used to electrically connect the cable assembly 110 to the circuit board 22. In other various embodiments, the socket connector 200 may be a cable connector provided at ends of cables (not shown) rather than a board connector.

In an exemplary embodiment, the communication system 10 includes the electronic package 30 electrically connected to the circuit board 22. In various embodiments, the electronic package 30 may be an integrated circuit assembly, such as an ASIC. However, the electronic package 30 may be another type of communication component, such as a processor, a memory module, or other type of communication component. The electronic package 30 may be mounted directly to the circuit board 22. For example, the electronic package 30 may be soldered to the circuit board 22. The cable assembly 110 is electrically connected to the electronic package 30 through the socket connector 200 and the circuit board 22. In various embodiments, multiple plug connectors 100 and socket connectors 200 may be provided at one or more sides, such as all four sides, of the electronic package 30.

The cable assemblies 110 are electrical modules using electrical conductors to transmit electrical data signals to/from the electronic package 30. In an exemplary embodiment, the socket connector 200 and corresponding cable assembly 110 are low profile connectors having a low profile or height measured from the top of the circuit board 22, such as to allow other components, such as a heat sink or other heat transfer device, to thermally couple to the electronic package 30.

In an exemplary embodiment, compression elements (not shown) are used to load the cable assemblies 110 against the socket connectors 200 to electrically connect the cable assemblies 110 to the socket connectors 200 and/or to electrically connect the socket connectors 200 to the circuit board 22. For example, the compression elements may include springs and/or clips and/or compression hardware that press the components downward to load the socket connectors 200 and create mechanical and electrical connections between the cable assemblies 110 and the socket connectors 200. In various embodiments, the cable assemblies 110 are individually clamped or compressed against the socket connectors 200 by the compression elements and are thus individually serviceable and removable from the socket connectors 200.

In an exemplary embodiment, the communication system 10 includes heat dissipating elements (not shown) to dissipate heat from the electronic package 30 and/or the cable assemblies 110. The heat dissipating elements may be heat sinks, cold plates, or other types of heat transfer elements.

The socket connector 200 is used to electrically connect the cable assembly 110 to the circuit board 22. The socket connector 200 is mounted to the circuit board 22. For example, the socket connector 200 is mounted to a mounting area on an upper surface 24 of the circuit board 22. The mounting area may be located adjacent to the electronic package 30. The circuit board 22 includes board contacts (not shown) at the mounting area. The board contacts may be arranged in an array, such as in rows and columns. The board contacts may be pads or traces of the circuit board 22. The board contacts may be spring beams in alternative embodiments. The board contacts may be a ball grid array (BGA), land grid array (LGA), or other type of interface. The board contacts may be high speed signal contacts, low speed signal contacts, ground contacts, or power contacts. The board contacts may include pairs of high-speed signal board contacts surrounded by a ring or fence of ground board contacts and/or a ground plane.

In an exemplary embodiment, the socket connector 200 is part of a socket assembly 210. The socket assembly 210 includes the socket connector 200 and a cage 220 with a cavity 224. The socket connector 200 is received in the cavity 224. The cavity 224 is configured to receive the plug connector 100 to mate with the socket connector 200. For example, the cable assembly 110 may be loaded into the cavity 224 through the top of the cage 220 to mate with the socket connector 200 from above in a downward mating direction. The cage 220 guides mating of the cable assembly 110 with the socket connector 200.

In an exemplary embodiment, the cage 220 is a stamped and formed cage configured to be stamped and formed from a metal sheet. The cage 220 includes cage walls 240 defining the cavity 224. The cage walls 240 extend between a top 242 and a bottom 244 of the cage 220. The bottom 244 is configured to be coupled to the circuit board 22. In an exemplary embodiment, the cage 220 includes a top opening 248 at the top 242. The top opening 248 is configured to receive the cable assembly 110. For example, the cable assembly 110 is top loaded into the cavity 224 through the top opening 248. The cage 220 may be manufactured by other processes in alternative embodiments, such as being molded (for example, cast, injection molded, etc.) and/or machined.

In an exemplary embodiment, the cage 220 includes side walls 250, 252 and end walls 254, 256. The side walls 250, 252 may be shorter than the end walls 254, 256. In the illustrated embodiment, the end wall 256 includes an opening 258. The opening 258 is configured to receive a portion of the cable assembly 110, such as the cables. In an exemplary embodiment, the cage 220 includes latching features 260 used for latchably coupling to the cable assembly 110. For example, the latching features 260 interface with the latches of the cable assembly 110 and/or a spring clip used to secure the cable assembly 110 in the cage 220. The spring clip engages the top of the cable assembly 110 and presses against the top of the cable assembly 110. The spring clip presses the cable assembly 110 toward the socket connector 200 to electrically connect the cable assembly 110 to the socket connector 200. The latching features 260 may be deflectable latches. Other types of latching features may be used in alternative embodiments, such as latch openings. The latching features 260 are provided at the side walls 250, 252 in the illustrated embodiment. However, the latching features 260 may be provided at other locations in alternative embodiments.

The electrical connector 200 includes an array of mating contacts 270. For example, in the embodiment of the socket connector, the socket connector 200 includes an array of socket contacts 270, which may be held by a substrate 272. The socket connector 200 may include a housing or socket frame 274 holding the substrate 272 or configured to hold the socket contacts 270 directly. The socket frame 274 may be rectangular. The socket frame 274 is configured to be coupled to the cage 220. Additionally, or alternatively, the socket frame 274 may be coupled to the circuit board 22. The socket frame 274 includes frame members 278 defining a space 276 that receives the plug connector 100, such as the cable assembly 110. In the illustrated embodiment the socket frame 274 is rectangular having the frame members 278 arranged around the perimeter of the socket frame 274 (for example, in a rectangular configuration). The socket frame 274 is configured to be coupled to the cage 220 and/or the circuit board 22. The socket frame 274 may include locating features, such as alignment walls, alignment walls, alignment openings, alignment slots, and the like for positioning the plug connector 100 in the space 276.

In various embodiments, the substrate 272 is a printed circuit board including the socket contacts 270 coupled to the printed circuit board. The socket contacts 270 may be defined by circuits, traces, vias, and the like of the printed circuit board. The socket contacts 270 may be separate contacts soldered to the printed circuit board. In other embodiments, the substrate 272 is a film or plate and the socket contacts 270 are separate contacts which may be held by or coupled to the film or plate. The substrate 272 is manufactured from an insulative material, such as a polyimide material, to electrically isolate the socket contacts 270 from one another.

In an exemplary embodiment, the socket contacts 270 are compressible contacts. In various embodiments, the socket contacts 270 may be stamped and formed contacts, such as dual compression contacts having spring beams at both ends of the contacts and main bodies of the contacts between the spring beams held in the substrate 272. The socket contacts 270 may be LGA contacts. In other various embodiments, the socket contacts 270 may be conductive polymer columns, such as conductive elastomeric connectors having conductive (metallic) particles embedded in an elastomeric material, such as a silicone rubber material. Each socket contact 270 includes an upper mating interface and a lower mating interface. In various embodiments, the socket contacts 270 are dual compressible contacts that are compressible at both the upper mating interface and the lower mating interface, such as for mating with the cable assembly 110 and the circuit board 22, respectively. Optionally, the socket contacts 270 may be arranged in groups, with each group including a pair of signal contacts surrounded by a ring or fence of ground contacts. The groups may be arranged in rows and columns. Other arrangements are possible in alternative embodiments.

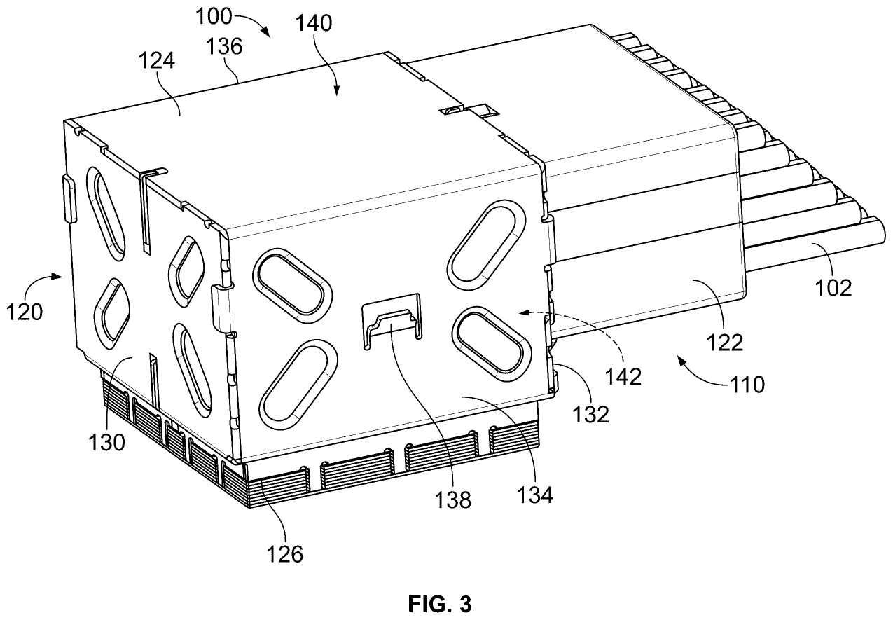

FIG. 3 is a perspective view of the plug connector 100 in accordance with an exemplary embodiment. The plug connector 100 includes the cable assembly 110 and a connector housing 120 that receives and/or surrounds portions of the cable assembly 110.

In an exemplary embodiment, the cable assembly 110 includes a plurality of the cables 102 with corresponding contact modules and ground structures for providing circumferential shielding for each cable and contact module through the cable assembly 110. The contact modules and ground structures are configured to be electrically connected to the socket connector 200 to provide shielded, high speed signal paths through the communication system 10. The ground structures provide circumferential or 360° shielding around each of the pairs of the signal transmission lines, such as along the entire transition zones between the cables 102 and the socket connector 200 providing robust signal integrity along the signal transmission lines. The ground structures may be manufactured from sheet metal construction that enable highly toleranced product design and control of the shielding structure for EMI shielding and signal integrity tunability. The ground structure provides efficient shielding around the signal transmission lines for improved high-frequency performance making the plug connector 100 suitable for applications requiring high data rates and bandwidth. The materials and design of the contact modules and ground structures result in reduced cross talk between adjacent signal transmission lines to maintain signal integrity in high density, high speed applications. The ground structure provides a consistent and gap-free conductive shield around the signal transmission lines ensuring improve signal transmission and reduced signal degradation. The contact modules provide stable impedance control along the signal transmission lines by controlling the dielectric material surrounding the signal transmission lines through the grounding structure for maintaining signal quality in the high speed data applications.

The connector housing 120 may hold or support the cable assembly 110. For example, the connector housing 120 includes a cable strain relief element 122 surrounding and holding the cables 102. The cable strain relief element 122 supports the cables 102, such as at the cable exit, such as to reduce stress or strain of the contact modules at the mating end. The cable strain relief element 122 may be an overmold formed in place around the cable assembly 110, such as around the cables 102. Alternatively, the cable strain relief element 122 may be pre-formed, such as molded pieces having cable channels formed therethrough that receive the cables 102.

In an exemplary embodiment, the connector housing 120 includes an outer plug shell 140 surrounding other components of the plug connector 100, such as the cable assembly 110 and the cable strain relief element 122. In various embodiments, the outer plug shell 140 may be conductive to provide shielding around the cable assembly 110. The outer plug shell 140 may be electrically connected to the cable assembly 110. In an exemplary embodiment, the outer plug shell 140 is configured to be coupled to the socket assembly 210, such as to the cage 220 (FIG. 1). The outer plug shell 140 may be electrically connected to the socket connector 200. In an exemplary embodiment, the outer plug shell 140 includes a shell cavity 142 that holds the cable assembly 110. The outer plug shell 140 may be a metal shell or cage that receives the cable assembly 110, such as a stamped and formed shell. Alternatively, the connector housing 120 may be a plated plastic component, a die cast component, and the like.

In an exemplary embodiment, the connector housing 120 extends between a top 124 and a bottom 126. The bottom 126 may be open to define an access port to allow access to the cable assembly 110 for mating with the socket connector 200. The connector housing 120 extends between a front 130 and a rear 132. The rear 132 may be open to allow the cables 102 to pass into/out of the cavity 142. In another example, the top 124 could be open for the cables 102 to pass therethrough, such as when the cables 102 extend vertically from the connector housing 120. The connector housing 120 includes sides 134, 136 between the front 130 and the rear 132. The connector housing 120 includes latching features 138 at the sides 134, 136 configured to interface with the socket connector 200 or a spring clip or other holding feature. The connector housing 120 may have other shapes and/or walls in alternative embodiments.

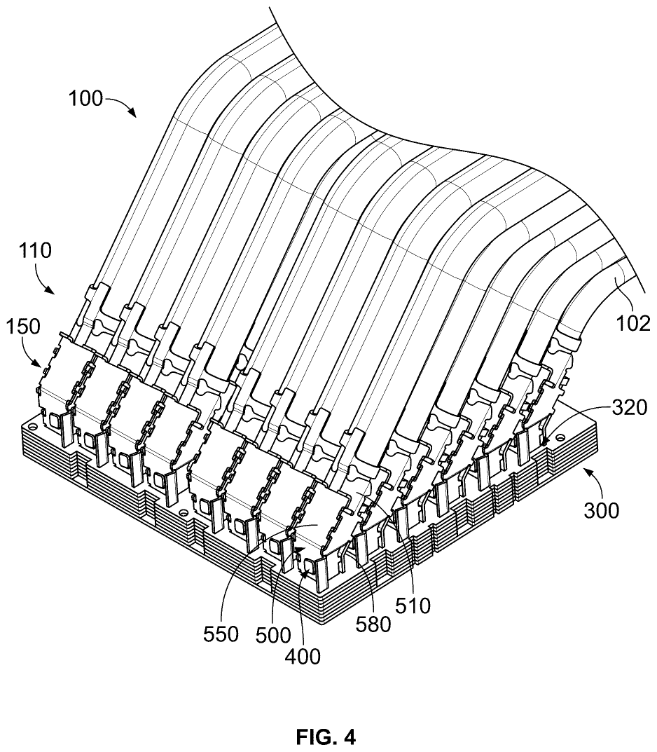

FIG. 4 is a perspective view of a portion of the plug connector 100 showing the cable assembly 110. The connector housing 120 (FIG. 3) is removed to illustrate the internal components of the plug connector 100. In an exemplary embodiment, the cable assembly 110 includes a plurality of the cables 102, cable termination modules 150 at ends of the cables 102 configured to be electrically connected to the socket connector 200, and a ground block 300 holding the cable termination modules 150. Grounding structures of the cable termination modules 150 are configured to be electrically connected to the ground block 300. The grounding structures of each of the cable termination modules 150 are configured to be electrically commoned by the ground block 300. In an exemplary embodiment, the ground block 300 is configured to be directly mated with the socket connector 200 to electrically connect the ground structure of the plug connector 100 with the ground structure of the socket connector 200. For example, the bottom of the ground block 300 forms a mating interface being directly coupled to the socket connector 200.

In an exemplary embodiment, each cable termination module 150 includes a contact module 400 and a ground cage 500 associated with the contact module 400. The contact modules 400 are configured to be coupled to the ends of the corresponding cables 102. The ground cages 500 are configured to be coupled to the cables 102. The ground cages 500 provide circumferential shielding for the ends of the cables 102 and the contact modules 400. The ground cages 500 are configured to be coupled to the ground block 300 to electrically connect the cable termination modules 150 to the ground block 300. The ground cages 500 and/or the contact modules 400 may control the cable exit direction, such as in a vertical direction or at a non-vertical exit angle. The ground cages 500 and/or the contact modules 400 may be angled to allow the cables 102 to exit at any desired or designed angle, such as an angle between 0° and 90°. In various embodiments, the cables 102 may exit at an angle between 30° and 60° relative to the ground block 300. Optionally, the cables 102 in different rows may exit at different angles. The ground cages 500 and/or the contact modules 400 hold the cables 102 at angles relative to the ground block 300 to allow the cables 102 to lift off of and away from the ground block 300, rather than laying flat or parallel to the ground block 300. Such an arrangement allows tighter packaging of the cable assemblies, such as to increase the density of the cable assembly 110 for a given footprint.

The ground block 300 is used to support the contact modules 400, the ground cages 500, and the cables 102. In an exemplary embodiment, the ground block 300 is electrically conductive to form part of the shielding structure for the signal transmission lines to provide shielding, with the ground cages 500, through the cable termination modules 150. For example, the ground block 300 may provide shielding from the ground cages 500 to the socket connector 200. The ground cages 500 may include mating elements configured to be mated to the ground block 300, such as spring beams, ground beams, connecting tabs, weld tabs, or other types of connecting elements. In an exemplary embodiment, the ground block 300 may be a solid metal block. The ground block 300 may be machined or die-cast. In alternative embodiments, the ground block 300 may be a laminate structure. For example, the ground block 300 may include a plurality of flat metal plates arranged in a plate stack. The laminated structure enables customization of the devices electrical and mechanical properties to suit specific application needs. In other various embodiments, the ground block 300 may be a plated plastic or a conductive plastic structure.

The ground block 300 includes pockets 320 that receive the corresponding contact modules 400 and ground cages 500. The pockets 320 may be arranged in an array, such as in multiple rows and/or columns. The pockets 320 may have varying hole patterns allowing for a tunable geometry for the plug connector 100. The pockets 320 may be designed for tight tolerances to fit into small pitch interconnect footprints. The pockets 320 may be open at the top and/or the bottom to receive the components. The pockets 320 locate the contact modules 400 relative to each other, such as for alignment and mating with the socket connector 200. The contact modules 400 may be held in precise alignment within the pockets 320 to ensure proper mating with the socket connector 200 and signal transmission for improved performance. In an exemplary embodiment, the contact modules 400 may be precisely vertically arranged within the ground block 300 such that the mating portions of the contact modules 400 are coplanar with the bottom surface of the ground block 300 such that the mating portions of the contact modules 400 and the bottom surface of the ground block 300 may be mated with the socket connector 200. In an exemplary embodiment, the bottom surface of the ground block 300 may maintain strict coplanar the requirements (for example, less than +/−0.020 mm coplanarity) for mating with the socket connector 200.

In an exemplary embodiment, the ground cages 500 are manufactured from multiple pieces. For example, each ground cage 500 includes a ferrule 510, a front cover 550 coupled to a front of the ferrule 510, and a rear cover 580 coupled to a rear of the ferrule 510. The front and rear front covers 550, 580 are configured to be coupled to the ferrule 510 to provide circumferential shielding around the ends of the corresponding cable 102 and the corresponding contact module 400. In various embodiments, a plurality of the front covers 550 and/or a plurality of the rear covers 580 may be ganged together in a strip configured to be coupled to the corresponding ferrules 510 and hold the ground cages 500 together as a unit.

The ferrule 510 may be a stamped and formed element configured to receive the end of the cable 102 and/or at least a portion of the contact module 400. The ferrule 510 is configured to be electrically connected to the cable shield 106, such as at multiple points of contact (for example, along the bottom and/or the right side and/or the left side of the cable). The ferrule 510 is configured to be electrically connected to the ground block 300, such as being welded, soldered, press-fit, connected by spring beams, or connected by other means. The ferrule 510 may be manufactured by other processes in alternative embodiments, such as being molded (for example, cast, injection molded, etc.) and/or machined.

The front cover 550 may be a stamped and formed element configured to cover the front end of the cable 102 and/or the contact module 400. The rear cover 580 may be a stamped and formed element configured to cover the rear end of the cable 102 and/or the contact module 400. The front and rear covers 550, 580 may be manufactured by other processes in alternative embodiments, such as being molded (for example, cast, injection molded, etc.) and/or machined. The front cover 550 is configured to be electrically connected to the ferrule 510, such as at one or more points of contact. The front cover 550 may be directly electrically connected to the cable shield 106, such as at one or more points of contact (for example, at a top of the cable). The rear cover 580 is configured to be electrically connected to the ferrule 510, such as at one or more points of contact. The rear cover 580 may be electrically connected to the cable shield 106, such as at one or more points of contact (for example, at a bottom of the cable). The front and rear front covers 550, 580 are configured to be electrically connected to the ferrule 510, such as being welded or soldered to the ferrule 510 or attached by a press fit or compression connection. The front and rear front covers 550, 580 are configured to be electrically connected to the ground block 300, such as being welded, soldered, press-fit, spring beams, or connected by other means.

In an exemplary embodiment, the ground cage 500 is used to electrically connect to the cable 102, such as to improve electrical performance of the cable assembly 110. For example, the ground cage 500 may reduce excess insertion loss and cross talk due to tighter control of electromagnetic fields at the termination area. The ground cage 500 may electrically connect to the cable 102 at multiple locations. For example, the ground cage 500 may electrically connect at the top, the bottom and both sides to provide nearly circumferential connection between the cable 102 and the ground cage 500. The ground cage 500 provides a short ground return path between the cable 102 and the socket connector 200 (via the ground block 300) for improved electrical characteristics. The ground cage 500 cooperates with the ground block 300 to provide shielding at the transition between the cables 102 and the socket connector 200, such as along the ends of the cables 102 and along the contact modules 400.

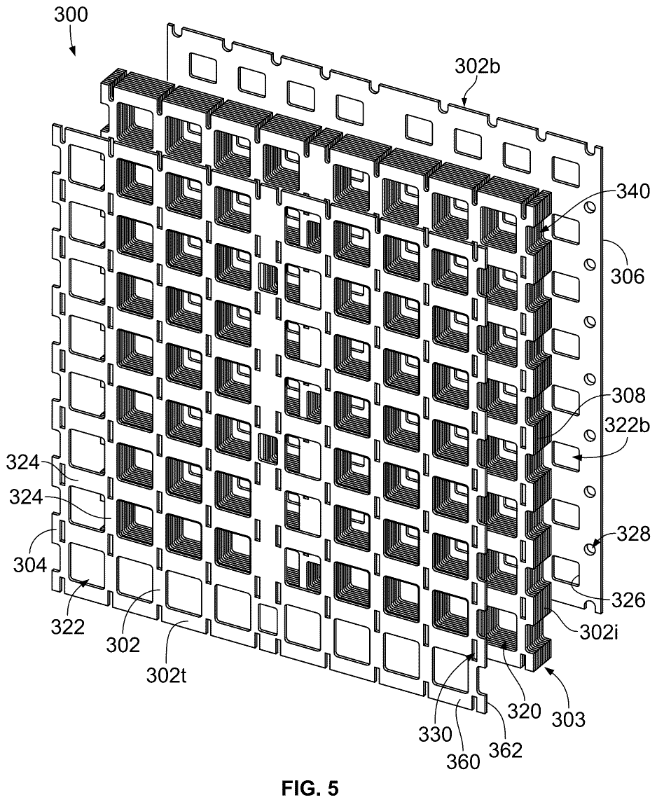

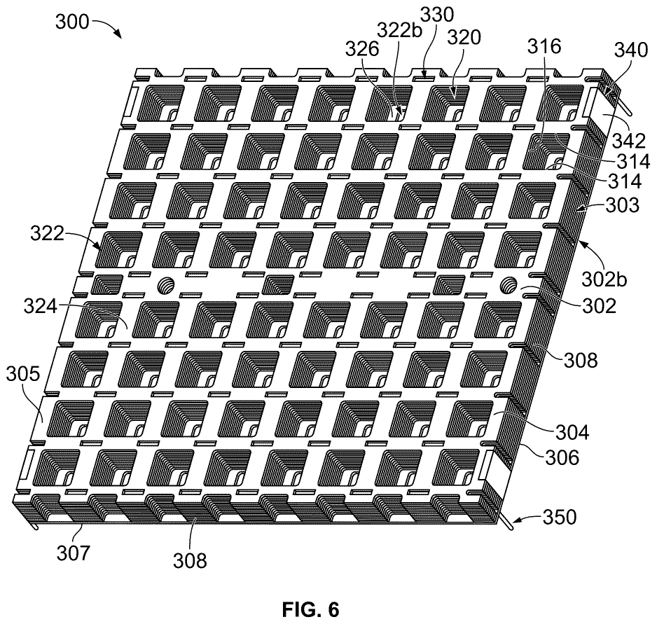

FIG. 5 is an exploded view of the ground block 300 in accordance with an exemplary embodiment. FIG. 6 is an assembled, top perspective view of the ground block 300 in accordance with an exemplary embodiment. In the illustrated embodiment, the ground block 300 is a laminated structure. For example, the ground block 300 includes a plurality of flat metal plates 302 arranged in a plate stack 303. In alternative embodiments, the ground block 300 may be a solid metal block, such as being a machined or die-cast component.

In the illustrated embodiment, the ground block 300 includes twelve plates 302 arranged in the plate stack 303. However, greater or fewer plates 302 may be provided in alternative embodiments. The plates 302 may have uniform thicknesses. Alternatively, one or more of the plates 302 may have different thicknesses. The plates 302 are manufactured from a conductive material, such as a metal material. For example, the plates 302 may be manufactured from a copper or copper alloy material. In an exemplary embodiment, the conductive material is a phosphor bronze allow, such as CuSn8 containing approximately 8% tin. The conductive material may contain between 7%-9% tin. The conductive material may contain between 0.01%-0.35% phosphorus. The conductive material may contain less than 0.01% iron. The conductive material may contain less than 0.005% lead. The conductive material may contain less than 0.02% zinc. The conductive material may have a conductivity of greater than 5.0 m/Ω·mm² (9% IACS). The conductive material may have high strength characteristics, good wear resistance characteristics, good corrosion resistance characteristics, good spring properties. In an exemplary embodiment, the conductive material is configured to be solderable and configured to be weldable.

The ground block 300 extends between a top 304 and a bottom 306. The ground block 300 has an upper surface 305 at the top 304 and a lower surface 307 at the bottom 306. The lower surface 307 defines a mating interface configured to be mated with the socket connector 200 to electrically connect the ground structure of the plug connector 100 with the ground structure of the socket connector 200. The ground block 300 includes sides 308 that extend between the top 304 and the bottom 306.

In an exemplary embodiment, the plates 302 include openings 322 with rails 324 between the openings 322. The openings 322 may pass through some or all of the plates 302. The rails 324 from a grid and extend longitudinally and laterally across the plate 302 between the sides 308. The rails 324 may be stacked on each other. The rails may be coupled together, such as being welded together. The plates 302 are arranged in the plate stack 303 with the openings 322 aligned to form the pockets 320. The pockets 320 pass through the plate stack 303 between the top 304 and the bottom 306 and are configured to hold the corresponding cable termination modules 150 (shown in FIG. 3).

In an exemplary embodiment, the ground block 300 includes side walls 314 and end walls 316 forming the pockets 320. The pockets 320 are arranged in an array in multiple rows and columns between the sides 308. In an exemplary embodiment, the ground block 300 has a thickness between the top and bottom of the ground block 300. The pockets 320 may have a lateral width and a longitudinal width across the pockets 320. In various embodiments, the lateral width and the longitudinal width dimensions may be within 10% of the thickness of the ground block 300. The lateral width and/or the longitudinal width may be equal to the thickness measurement of the ground block 300. In various embodiments, the ground block 300 has a thickness of approximately 1.2 mm. The ground block 300 may have other thicknesses in alternative embodiments. Each plate may have a thickness of approximately 0.1 mm. The pockets 320 may have a lateral width of approximately 1.3 mm. The pockets 320 may have a longitudinal width of approximately 1.0 mm. The pockets 320 may have other widths in alternative embodiments.

In an exemplary embodiment, the ground block 300 includes slots 330 adjacent the pockets 320. The slots 330 are formed in the rails 324. The slots 330 may pass through some or all of the plates 302. The slots 330 are configured to receive portions of the ground cages 500. For example, portions of the ground cages 500 may be press-fit into the slots 330. The slots 330 may be rectangular. Other shapes are possible in alternative embodiments, such as dog-bone or hour-glass shaped being smaller in the central region and wider at the ends. The dog-bone shape may provide a central region for compression fit and/or welding to portions of the ground cages 500 plugged into the slots 330 to create mechanical and electrical connections with the ground cages 500. In the illustrated embodiment, the slots 330 are open at the top 304 of the ground block 300 to receive the ground cages 500. The slots 330 may be open at the bottom 306 of the ground block 300, such as for welding the ground cages 500 to the ground block 300.

In an exemplary embodiment, the ground block 300 includes wells 340. The wells 340 are configured to receive plugs 342 or other fixturing tools used to align and/or join the plates 302 in the plate stack 303. The plugs 342 may be welded or soldered to the plates 302 to hold the plates 302 in the plate stack 303. The wells 340 may receive other components, such as the outer plug shell 140 to join the ground block 300 to the outer plug shell 140. In the illustrated embodiment, the wells 340 are located in the sides 308. Other locations are possible in alternative embodiments. In an exemplary embodiment, the wells 340 are open at the top 304 to receive the plugs 342. The wells 340 may be open at the sides 308.

In an exemplary embodiment, the ground block 300 includes alignment elements 350 at the top 304 and/or the bottom 306. The alignment elements 350 are used to align the ground block 300 to the socket connector 200 and/or the connector housing 120. The alignment elements 350 may be pins, posts, tabs, slots, grooves, openings, or other types of locating features. The alignment elements 350 may interact with corresponding alignment elements of the socket connector 200 to align to the socket connector 200, such as posts extending from the socket connector 200.

In an exemplary embodiment, the plates 302 are stamped plates. The plates 302 may be manufactured by other processes in alternative embodiments, such as being molded (for example, cast, injection molded, etc.) and/or machined. The plates 302 may be thin and planar. Providing different plates that are stamped rather than a thick metal block that is machined allows manufacturing of the ground block 300 to exacting tolerances because the plates 302 may be more precisely made than machining a thick metal block. The high precision manufacturing ensures that each resident cavity within the structure is nearly identical to the adjacent cavities promoting signal integrity and minimizing variations in electrical performance. Each plate 302 includes an upper surface 360 and a lower surface 362. The openings 322 pass through the plate 302 between the upper surface 360 and the lower surface 362. The plate 302 has a thickness between the upper surface 360 and the lower surface 362. Optionally, the thicknesses of the various plates 302 may be the same for all plates 302 within the plate stack 303. Alternatively, the thicknesses of the various plates 302 may be different for some of the plates 302 within the plate stack 303. For example, the thicknesses may be different for mechanical reasons, such as for forming a mechanical connection layer with the ground cages 500 or for providing rigidity or robustness to the plate stack 303. The thicknesses may be selected to control impedance or control other electrical characteristics along the signal lines passing through the ground block 300. The size of the openings 322 may be the same for all plates 302 within the plate stack 303. Alternatively, the size of the openings 322 in the various plates 302 may be different for some of the plates 302 within the plate stack 303. For example, the sizes of the openings 322 may be larger or smaller in some of the plates 302 to control impedance or control other electrical characteristics along the signal lines passing through the ground block 300.

In an exemplary embodiment, the plates 302 in the plate stack 303 include a top plate 302t, a bottom plate 302b, and inner plates 302i between the top and bottom plates 302t, 302b. The top plate 302t may be different from the other plates 302. The bottom plate 302b may be different from the other plates 302. For example, the openings 322b in the bottom plate 302b may be smaller longitudinally and/or laterally such that the bottom openings 322b reduce the size of the pockets 320 at the bottom layer.

In an exemplary embodiment, locating surfaces 326 (FIG. 6) are formed by the bottom plate 302b at the bottom of the pockets 320. The locating surfaces 326 may be used for locating the cable termination modules 150 relative to the ground block 300. For example, the locating surfaces 326 may be used to vertically position the cable termination modules 150 in the pockets 320. For example, the locating surfaces 326 may form loading stops for loading the cable termination modules 150 into the pockets 320. Other types of locating features may be used in alternative embodiments, such as features for longitudinal and/or lateral positioning of the cable termination modules 150 in the pockets 320. The locating features may be part of the ground block 300 or may be a separate locating or fixturing tool for positioning of the cable termination modules 150 in the pockets 320.

In an exemplary embodiment, the bottom plate 302b includes openings 328 rather than the slots 330. The openings 328 may have different shapes than the slots 330. For example, the openings 328 may be circular. The openings 328 may have other shapes in alternative embodiments. The openings 328 may be sized and shaped to block pass through of the ground cages 500 through the openings 328. For example, the bottom plate 302b may form a stop surface for the ground cages 500 during assembly. The openings 328 are aligned with the slots 330. For example, the slots 330 and the portions of the inner plates 302i in the slots 330 may be accessed from below through the openings 328, such as for welding.

FIG. 7 is a bottom view of a portion of one of the ground plates 302 in accordance with an exemplary embodiment. The plate 302 may be held by a carrier 301 during the stamping and manufacture process, wherein the carrier 301 is removed or separated at a later stage.

The plate 302 includes the openings 322 arranged in rows and columns and the rails 324 between the openings 322. The slots 330 are formed in the rails 324 adjacent the openings 322. In the illustrated embodiment, the slots 330 are dog-bone or hour-glass shaped being smaller in the central region and wider at the ends. The central region may extend inward to engage or compress against connection portions of the ground cages 500 when the connection portions are plugged into the slots 330, such as to form a close fit with the connection portions for welding to the ground cages 500. In an exemplary embodiment, the slots 330 around the outer perimeter (outer slots) may be sized smaller than the slots 330 in the interior of the plate 302 (inner slots) because the outer slots may receive a connection portion from single ground cage 500 whereas the inner slots receive the connection portions from two of the ground cages 500.

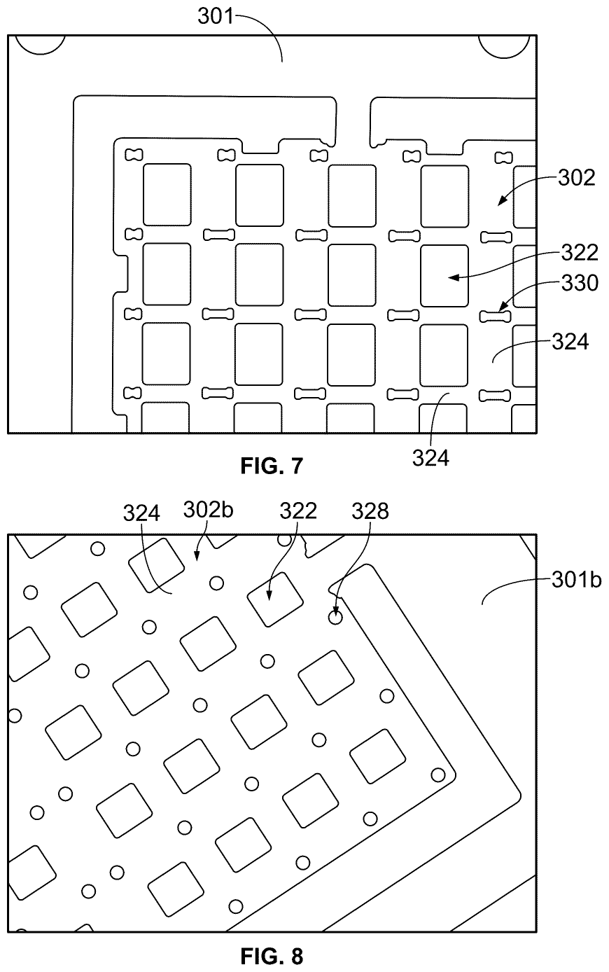

FIG. 8 is a bottom view of a portion of the bottom ground plate 302b in accordance with an exemplary embodiment. The bottom plate 302b may be held by a carrier 301b during the stamping and manufacture process, wherein the carrier 301b is removed or separated at a later stage.

The bottom plate 302 includes the openings 322 arranged in rows and columns and the rails 324 between the openings 322. In an exemplary embodiment, the openings 322 are smaller (shorter and/or narrower in the longitudinal and/or lateral direction(s)) than the openings 322 (shown in FIG. 7) of the other plates 302.

The openings 328 are formed in the rails 324 adjacent the openings 322. In the illustrated embodiment, the openings 328 have different shapes than the slots 330 (FIG. 7). For example, the openings 328 may be circular. The openings 328 may have other shapes in alternative embodiments. The openings 328 may be sized and shaped to block pass through of the connection portions of the ground cages 500 through the openings 328. The openings 328 may be aligned with the slots 330 to access the connection portions of the ground cages 500 and the rails 324 of the plate 302 surrounding the slots 330 from below through the openings 328 for welding.

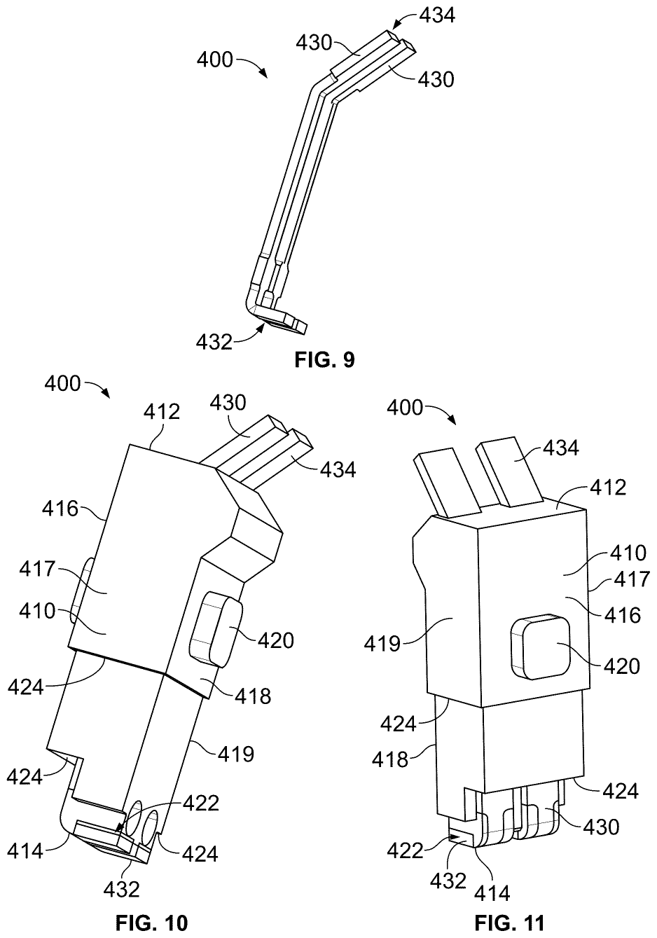

FIG. 9 is a perspective view of a portion of the contact module 400 in accordance with an exemplary embodiment. FIG. 10 is a rear perspective view of a portion of the contact module 400 in accordance with an exemplary embodiment. FIG. 11 is a front perspective view of a portion of the contact module 400 in accordance with an exemplary embodiment.

The contact module 400 includes a contact holder 410 (FIGS. 10 and 11) holding one or more contacts 430. In an exemplary embodiment, the contact holder 410 holds a pair of the contacts 430. The contacts 430 may be stamped and formed contacts. The contacts 430 are manufactured from a conductive material, such as a metal material. For example, the contacts 430 may be manufactured from a copper or copper alloy material. In an exemplary embodiment, the conductive material is a phosphor bronze allow, such as CuSn8 containing approximately 8% tin. The conductive material may contain between 7%-9% tin. The conductive material may contain between 0.01%-0.35% phosphorus. The conductive material may contain less than 0.01% iron. The conductive material may contain less than 0.005% lead. The conductive material may contain less than 0.02% zinc. The conductive material may have a conductivity of greater than 5.0 m/Ω·mm² (9% IACS). The conductive material may have high strength characteristics, good wear resistance characteristics, good corrosion resistance characteristics, good spring properties. In an exemplary embodiment, the conductive material is configured to be solderable and configured to be weldable. The contacts 430 may be differential pairs configured to convey differential signals. The contact holder 410 holds the relative positions of the contacts 430, such as holding the contacts 430 along parallel paths through the contact module 400. The contact holder 410 may be overmolded over the contacts 430. In alternative embodiments, the contacts 430 may be inserted into the contact holder 410, such as into channels formed in the contact holder 410. The contacts 430 are configured to be electrically connected to the corresponding cables 102. The contacts 430 are configured to be electrically connected to the socket connector 200 (FIG. 2).

The contact holder 410 is manufactured from a dielectric material, such as a plastic material. For example, the contact holder 410 may be a molded structure, such as an injection molded part. The contact holder 410 may be an overmold body overmolded over the contacts 430. For example, the contact holder 410 may be formed in place around the contacts 430. The contact holder 410 extends between a top 412 and a bottom 414. The contact holder 410 includes a first end or front 416 and a second end or rear 418. The contact holder 410 includes a first side 417 between the first and second ends 416, 418 and a second side 419 between the first and second ends 416, 418.

In an exemplary embodiment, the contact holder 410 includes one or more securing features 420 used to secure the contact holder 410 in the ground cage 500. In the illustrated embodiment, the securing features 420 include heat stake tabs protruding from the front 416 and/or the rear 418 that are configured to be heat staked to the ground cage 500. Other types of securing features 420 may be used in alternative embodiments, such as crush ribs, clips, latches, fasteners, and the like. The contact holder 410 are configured to be securely fixed relative to the ground cage 500 to ensure stable electrical connections and maintain the desired impedance characteristics throughout the cable termination module 150.

In an exemplary embodiment, the contact holder 410 includes pockets 422 at the bottom configured to receive portions of the contacts 430. The contacts 430 may sit flush with the bottom 414 of the contact holder 410 in the pockets 422. In an exemplary embodiment, the contact holder 410 includes alignment elements 424 for aligning or positioning the contact module 400 in the ground cage 500 and/or in the ground block 300. The alignment elements 424 may include walls, surfaces, tabs, pins, posts, openings, grooves, slots, or other types of alignment features. The alignment elements 424 may be used to vertically align the contact holder 410, longitudinally align the contact holder 410 and/or laterally align the contact holder 410 relative to the ground cage 500 and/or the ground block 300.

The contacts 430 pass through the contact holder 410. Each contact 430 includes a connecting end 432 and a terminating end 434. The connecting end 432 is configured to be mated directly to the socket connector 200. In the illustrated embodiment, the connecting end 432 includes a connecting pad configured to be coupled to the corresponding socket contact of the socket connector 200. The connecting pad may be bent at an angle, such as a right angle, such that the connecting pad extends along the bottom of the contact module 400 and is configured to be pressed downward onto the compressible interface of the socket connector 200. However, other types of connecting ends may be used in alternative embodiments, such as a spring beam, a solder tail, a solder ball, a pin, a socket, or another type of connecting end. The connecting end 432 is exposed at the bottom 414 of the contact holder 410 for connection to the socket connector 200.

The terminating end 434 is configured to be electrically connected to the conductor of the cable 102. In the illustrated embodiment, the terminating end 434 includes a pad configured to be soldered or welded to the conductor of the cable 102 (for example, weld pad). Other types of terminating ends may be provided in alternative embodiments, such as a crimped barrel, and IDC connector, and the like. In an exemplary embodiment, the terminating end 434 extends from the contact holder 410, such as from the top 412. As such, the terminating end 434 is exposed above the top 412 of the contact holder 410 for connection to the conductor of the cable 102.

In the illustrated embodiment, the terminating end 434 is bent at an angle relative to the connecting end 432 for connection to the conductor of the cable 102. For example, the terminating end 434 may be bent at an angle corresponding to the exit angle of the cable 102 to allow the conductors to extend parallel to the axis of the cable 102. In the illustrated embodiment, the terminating end 434 is at an angle of between 30° and 60° relative to the vertical axis, however the terminating end 434 may be oriented at other angles, such as any angle between 0° and 90°. In various embodiments, the terminating end 434 may be oriented vertically or may be oriented horizontally.

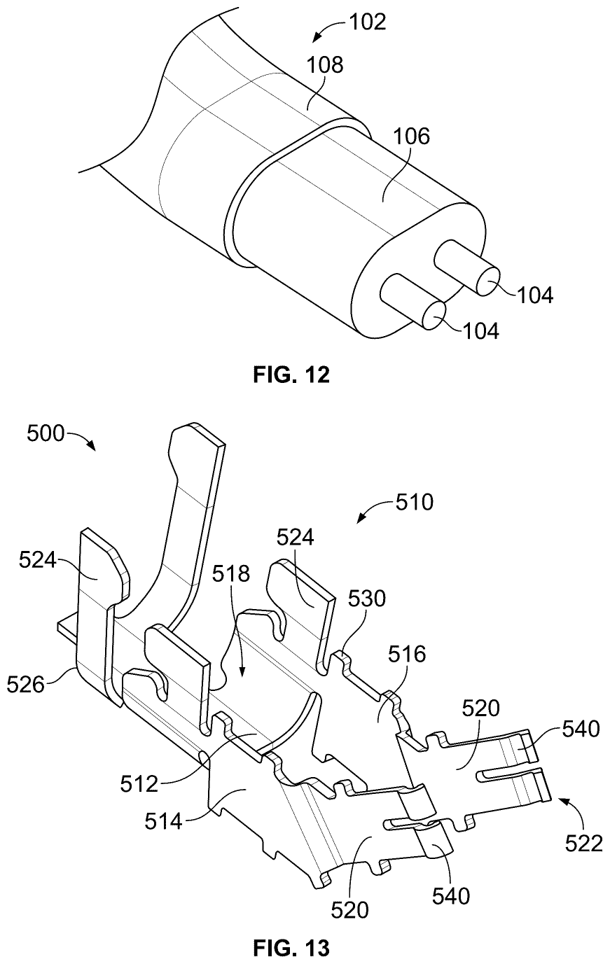

FIG. 12 illustrates an end of one of the cables 102 in accordance with an exemplary embodiment. The cable 102 includes at least one signal conductor and a shield structure providing electrical shielding for the at least one signal conductor. In an exemplary embodiment, the cable 102 is a twin-axial cable. For example, the cable 102 includes first and second signal conductors 104 held by one or more insulators. The signal conductors 104 carry differential signals. The signal conductors 104 are configured to be terminated to ends of the corresponding contacts 430.

The cable 102 includes a cable shield 106 surrounding the insulator and the signal conductors 104 to provide circumferential shielding around the signal conductors 104. The cable 102 includes a cable jacket 108 surrounding the cable shield 106. In various embodiments, the cable 102 may or may not include one or more drain wires electrically connected to the cable shield 106, such as a pair of drain wires extending along opposite sides of the cable 102 between the cable shield 106 and the cable jacket 108. In an exemplary embodiment, at an end of the cable 102, the cable jacket 108, the cable shield 106, and the insulator may be removed (e.g., stripped) to expose portions of the signal conductors 104. The exposed portions of the signal conductors 104 are configured to be mechanically and electrically coupled (e.g., welded, soldered, crimped, etc.) to corresponding contacts of the contact module 400. For example, the exposed portions of the signal conductors 104 may be butt welded or lap welded to the contacts 430 at weld joints.

FIG. 13 is a perspective view of the ferrule 510 of the ground cage 500 in accordance with an exemplary embodiment. The ferrule 510 is manufactured from a conductive material, such as a metal material. For example, the ferrule 510 may be manufactured from a copper or copper alloy material. In an exemplary embodiment, the conductive material is a phosphor bronze allow, such as CuSn8 containing approximately 8% tin. The conductive material may contain between 7%-9% tin. The conductive material may contain between 0.01%-0.35% phosphorus. The conductive material may contain less than 0.01% iron. The conductive material may contain less than 0.005% lead. The conductive material may contain less than 0.02% zinc. The conductive material may have a conductivity of greater than 5.0 m/Ω·mm² (9% IACS). The conductive material may have high strength characteristics, good wear resistance characteristics, good corrosion resistance characteristics, good spring properties. In an exemplary embodiment, the conductive material is configured to be solderable and configured to be weldable. In an exemplary embodiment, the ferrule 510 is a stamped and formed part.

The ferrule 510 includes a base wall 512, a first side wall 514 extending from a first side of the base wall 512, and a second side wall 516 extending from a second side of the base wall 512. The ferrule 510 includes a cradle 518 formed by the base wall 512, the first side wall 514, and the second side wall 516. The cradle 518 is configured to receive the cable 102. The base wall 512 may be provided at the top or at the bottom of the ferrule 510. The cradle 518 may be open opposite the base wall 512, such as at the top or the bottom between the first and second side walls 514, 516 to receive the cable 102. The base wall 512 is used to engage and support a portion of the cable 102. The first side wall 514 is used to engage and support a first side of the cable 102. The second side wall 516 is used to engage and support a second side of the cable 102. In the illustrated embodiment, the first and second side walls 514, 516 extend generally perpendicular from the base wall 512. The corners where the first and second side walls 514, 516 intersect with the base wall 512 may be curved, such as generally following a curvature of the cable 102. In alternative embodiments, rather than being a single piece, the ferrule 510 may be multiple pieces, such as having separate first and second side walls 514, 516 configured to be coupled together by other pieces, such as the base wall 512 or the front and rear covers 550, 580 (FIG. 4).

In an exemplary embodiment, the ferrule 510 includes shield walls 520 at a bottom 522 of the ferrule 510. The shield walls 520 extend downward from the first and second side walls 514, 516. The shield walls 520 may support portions of the contact module 400. The shield walls 520 provide shielding along portions of the contact module 400. The shield walls 520 may be coupled to the ground block 300.

In an exemplary embodiment, the ferrule 510 includes crimp tabs 524 at a top 526 of the ferrule 510. The crimp tabs 524 extend from the base wall 512. The crimp tabs 524 are located above of the side walls 514, 516. The crimp tabs 524 are configured to be crimped to the cable 102 to mechanically secure the ferrule 510 to the end of the cable 102. The crimp tabs 524 may be electrically connected to the cable 102, such as by crimping to the cable shield of the cable 102.

In an exemplary embodiment, the ferrule 510 includes connecting tabs 530 extending from the side walls 514, 516. The connecting tabs 530 are configured to be connected to the front cover 550 and/or the rear cover 580 (both shown in FIG. 4) of the ground cage 500. For example, the connecting tabs 530 may be welded to the front cover 550 and/or the rear cover 580. In the illustrated embodiment, the connecting tabs 530 are rectangular-shaped. However, the connecting tabs 530 may have other shapes in alternative embodiments. The connecting tabs 530 may include dimples or spring beams configured to form a mechanical press-fit connection with the cover 550.

In an exemplary embodiment, the shield walls 520 include one or more ground beams 540. The ground beams 540 may extend downward at the bottom of the shield walls 520. In an exemplary embodiment, the ground beams 540 are deflectable and configured to be coupled to the ground block 300. For example, when the ground cage 500 is plugged into the ground block 300, the ground beams 540 may interface with the ground block 300 to deflect and electrically connect the ground cage 500 to the ground block 300. The ground beams 540 may include curved ends to form mating interfaces configured to directly engage the ground block 300. In the illustrated embodiment, multiple ground beams 540 are provided on each shield wall 520. The ground beams 540 extend parallel to each other. The ground beams 540 are separated by slots to allow the ground beams 540 to move independently. The ground beams 540 may be used as locating or alignment features to locate or align the cable termination module 150 in the pocket 320 of the ground block 300 (for example, for lateral or longitudinal positioning).

In various embodiments, the shield walls 520 may include retention barbs (not shown) extending therefrom, such as from the side edges of the shield walls 520. The retention barbs may be press-fit into the pocket in the ground block 300 to create a mechanical and electrical connection to the ground block 300. The retention barbs may be used as locating or alignment features to locate or align the cable termination module 150 in the pocket 320 of the ground block 300 (for example, for lateral or longitudinal positioning).

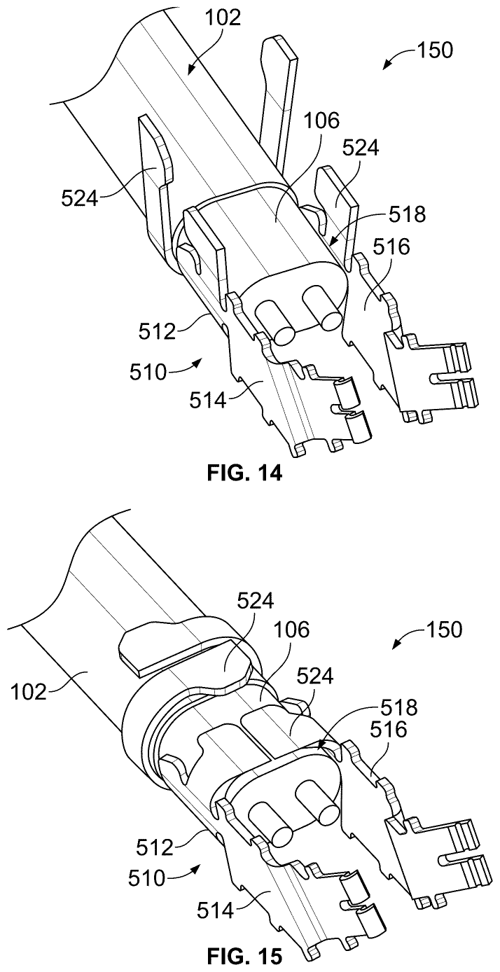

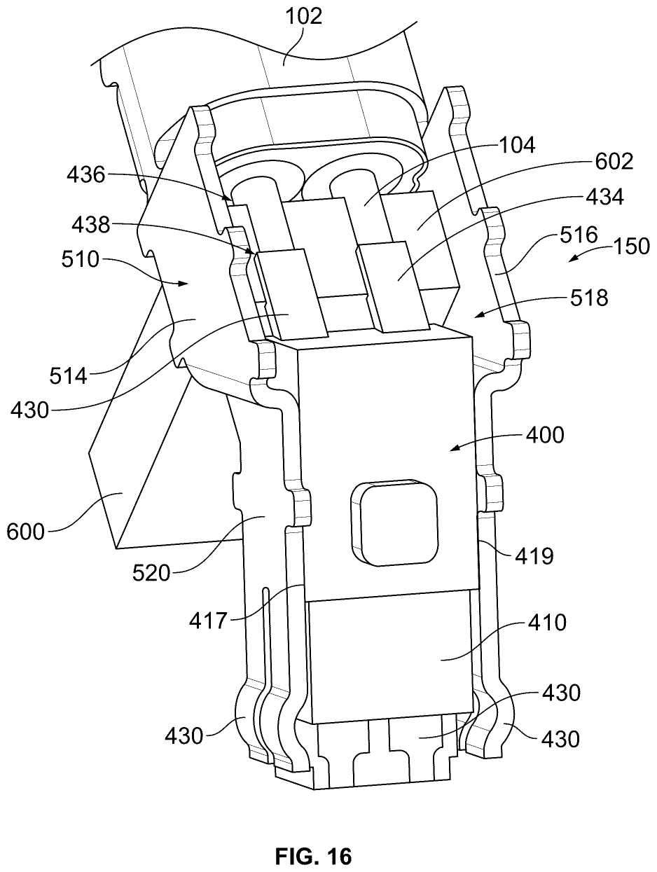

FIG. 14 is a perspective view of a portion of the cable termination module 150 showing the ferrule 510 positioned relative to the cable 102. FIG. 15 is a perspective view of a portion of the cable termination module 150 showing the ferrule 510 positioned relative to the cable 102. FIG. 14 shows the ferrule 510 in an uncrimped state. FIG. 15 shows the ferrule 510 in a crimped state.

During assembly, the cable 102 is received in the cradle 518. The cradle 518 is seated against the base wall 512, the first side wall 514, and the second side wall 516. During assembly, the crimp tabs 524 are crimped to the cable 102 to mechanically secure the ferrule 510 to the end of the cable 102. The crimp tabs 524 may be electrically connected to the cable 102, such as by crimping to the cable shield 106 of the cable 102. In various embodiments, the crimp tabs 524 may be soldered to the cable shield 106.

FIG. 16 is a perspective view of a portion of the cable termination module 150 showing the contact module 400 positioned relative to the ferrule 510 and the cable 102 at a termination interface 436. The termination interface 436 is located between the top 412 of the contact holder 410 and the end of the cable 102. The exposed portions of the signal conductors 104 and the exposed portions of the terminating ends 434 of the contacts 430 extend into the termination area to define the termination interface 436. The side walls 514, 516 of the ferrule 510 provide shielding along the termination area.

FIG. 16 shows an assembly tool 600 used during the assembly process. The assembly tool 600 includes an edge 602 used to support the ends of the conductors 104 and the terminating ends 434 of the contacts 430 to position the contact module 400 relative to the cable 102. The assembly tool 600 is removed after the contacts 430 are terminated to the ends of the cable 102.

During assembly, the contact module 400 is loaded into the cradle 518 between the side walls 514, 516. The shield walls 520 may extend along the sides 417, 419 of the contact holder 410. The ground beams 540 extend along the sides 417, 419. The ground beams 540 may extend along the contacts 430, such as along both sides of the contacts 430. The contact holder 410 electrically isolates the shield walls 520 from the contacts 430. The material of the contact holder 410 and the spacing between the shield walls 520 and the contacts 430 control the impedance along the signal transmission lines. In an exemplary embodiment, the terminating ends 434 of the contacts 430 may be welded or soldered to the ends of the conductors 104 at the termination area. For example, the terminating ends 434 may be butt welded to the ends of the conductors 104 at a butt weld joint 438 (for example, a butt weld joint). Alternatively, the terminating ends 434 may be lap welded to the ends of the conductors 104 at a lap weld joint.

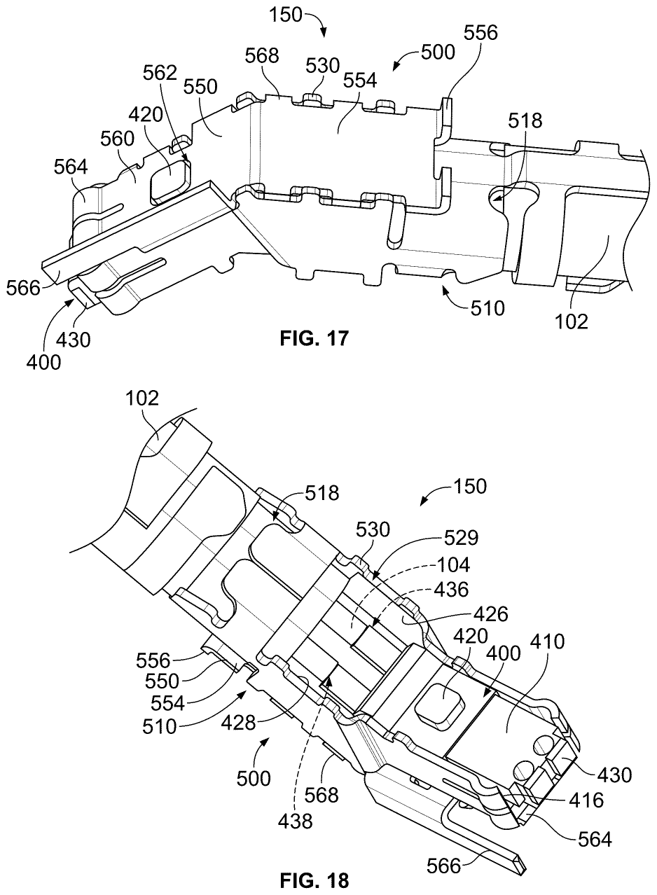

FIG. 17 is a front perspective view of a portion of the cable termination module 150 showing the front cover 550 coupled to the ferrule 510 in accordance with an exemplary embodiment. FIG. 18 is a rear perspective view of a portion of the cable termination module 150 showing the front cover 550 coupled to the ferrule 510 in accordance with an exemplary embodiment.

During assembly, the front cover 550 is coupled to the front of the ferrule 510. The front cover 550 is electrically coupled to the ferrule 510. For example, the front cover 550 may be welded or soldered to the ferrule 510. In alternative embodiments, the front cover 550 may be stamped and formed with the ferrule 510, such as being an integral part of the ferrule 510. The front cover 550 may cover a portion of the cradle 518. The front cover 550 covers a portion of the contact module 400 to provide electrical shielding, such as along the front of the contact module 400.

The front cover 550 is manufactured from a conductive material, such as a metal material. For example, the front cover 550 may be manufactured from a copper or copper alloy material. In an exemplary embodiment, the conductive material is a phosphor bronze allow, such as CuSn8 containing approximately 8% tin. The conductive material may contain between 7%-9% tin. The conductive material may contain between 0.01%-0.35% phosphorus. The conductive material may contain less than 0.01% iron. The conductive material may contain less than 0.005% lead. The conductive material may contain less than 0.02% zinc. The conductive material may have a conductivity of greater than 5.0 m/Ω·mm² (9% IACS). The conductive material may have high strength characteristics, good wear resistance characteristics, good corrosion resistance characteristics, good spring properties. In an exemplary embodiment, the conductive material is configured to be solderable and configured to be weldable. In an exemplary embodiment, the front cover 550 is a stamped and formed part. A plurality of the front covers 550 may be stamped from a single metal sheet and connected by tie bars or other connecting structures.

The front cover 550 includes a cover wall 554 configured to extend along the front of the cable 102 and the corresponding ferrule 510 to cover the front of the cable 102. In an exemplary embodiment, the cover wall 554 includes one or more press tabs 556 configured to be pressed by a pressing tool during loading of the cable termination modules 150 into the ground block 300. The front cover 550 may include additional walls in alternative embodiments, such as side walls configured to extend along sides of the cable 102.

In an exemplary embodiment, the front cover 550 includes a shield wall 560 extending from the cover wall 554. In the illustrated embodiment, the shield wall 560 may extend downward from the front of the cover wall 554. The shield wall 560 may extend at an angle relative to the cover wall 554. The shield wall 560 provides shielding along the front of the contact module 400. In an exemplary embodiment, the shield wall 560 includes an opening 562. The opening 562 receives the securing feature 420 of the contact holder 410. The securing feature 420 may be heat staked to the front cover 550.

The shield wall 560 is configured to be coupled to the ground block 300. For example, the shield wall 560 may include one or more ground beams 564. The ground beams 564 may extend downward at the bottom of the shield wall 560. The ground beams 564 may extend along the first side 416 (for example, front) of the contact holder 410. The ground beams 564 may extend along the contacts 430 (for example, forward of the contacts 430). In an exemplary embodiment, the ground beams 564 are aligned with the contacts 430, such as aligned with corresponding contacts 430.

In an exemplary embodiment, the ground beams 564 are deflectable and configured to be coupled to the ground block 300. For example, when the ground cage 500 is plugged into the ground block 300, the ground beams 564 may interface with the ground block 300 to deflect and electrically connect the ground cage 500 to the ground block 300. The ground beams 564 may include curved ends to form mating interfaces configured to directly engage the ground block 300. In the illustrated embodiment, multiple ground beams 564 are provided on each shield wall 560. The ground beams 564 extend parallel to each other. The ground beams 564 are separated by slots to allow the ground beams 564 to move independently. The ground beams 564 may be used as locating or alignment features to locate or align the cable termination module 150 in the pocket 320 of the ground block 300 (for example, for lateral or longitudinal positioning).

In various embodiments, the shield wall 560 may include one or more retention barbs (not shown) extending therefrom, such as from the side edges of the shield wall 560. The retention barbs may be press-fit into the pocket in the ground block 300 to create a mechanical and electrical connection to the ground block 300. The retention barbs may be press-fit into the pocket 320 in the ground block 300 to create a mechanical and electrical connection to the ground block 300. The retention barbs may be used as locating or alignment features to locate or align the cable termination module 150 in the pocket 320 of the ground block 300 (for example, for lateral or longitudinal positioning).

In an exemplary embodiment, the front cover 550 includes one or more locating or alignment features to locate or align the cable termination module 150 in the pocket 320 of the ground block 300 (for example, for lateral or longitudinal positioning). In an exemplary embodiment, the locating or alignment features include a connecting leg 566 extending from the shield wall 560 or the cover wall 554. The connecting leg 566 is configured to be plugged into the ground block 300, such as into the corresponding slot 330 in the ground block 300. The connecting leg 566 is configured to be mechanically and/or electrically connected to the ground block 300 in the slot 330. For example, the connecting leg 566 may be welded or soldered to the ground block 300, such as along the side(s), along the edge(s), and or at the distal end thereof. In other embodiments, the connecting leg 566 may be connected by an interference fit.

In an exemplary embodiment, the front cover 550 includes connecting tabs 568 extending from the side edges of the cover wall 554 and/or the shield wall 560. The connecting tabs 568 are configured to be connected to the ferrule 510. For example, the connecting tabs 568 may be welded to the ferrule 510. The connecting tabs 568 may internest with the connecting tabs 530 to form welding surfaces or pockets. In the illustrated embodiment, the connecting tabs 568 are rectangular-shaped. However, the connecting tabs 568 may have other shapes in alternative embodiments.

In an exemplary embodiment, after the front cover 550 is coupled to the ferrule 510, the termination area or space surrounding the termination interface 436 may receive a termination support 426. For example, the termination area surrounding the exposed portions of the conductors 104 and the contacts 430 may be filled with support material 428 that supports the termination interface 436. In an exemplary embodiment, the front cover 550, the side walls 514, 516 of the ferrule 510, the top 412 of the contact holder 410, and the end of cable 102 form a well 529 the receives and contains the support material 428. The termination support 426 is configured to be coupled to the front cover 550 and/or the ferrule 510 and/or the contact holder 410 and/or the end of cable 102.

The termination support 426 provides strain relief for the weld between the conductors 104 and the contacts 430. For example, the termination support 426 may provide support for the butt weld joints 438. The termination support 426 may be formed in place in the termination area/space. For example, the support material 428 may be injected, poured, or otherwise loaded into the termination area around the termination interface 436. The support material 428 is conformable, such as to conform to the exposed portions of the signal conductors 104 and the terminating ends 434 of the contacts 430. The support material 428 may be contained by the front cover 550 and/or the ferrule 510 and/or the contact holder 410 and/or the end of cable 102. For example, the support material 428 may fill the interior space between the side walls 514, 516 and behind the front cover 550. The support material 428 may be cured or hardened after placement to remain fixed in the termination area. The support material 428 is a dielectric material. In various embodiments, the support material 428 may be hot melt, epoxy, room temperature vulcanizing (RVT) material, or other formable material. The support material 428 may be cured by exposure to air, ultraviolet light, or other curing means. The type of material is selected to control impedance along the signal transmission lines. The support material 428 may have a dielectric constant above 1.0 to control the impedance through the termination area. In various embodiments, the support material 428 may have a dielectric constant above 2.0 to control the impedance through the termination area. In various embodiments, the support material 428 may have a dielectric constant above 3.0 to control the impedance through the termination area. The dielectric constant of the support material 428 may be similar to the dielectric constant of the contact holder 410 and/or the insulator of the cable 102.

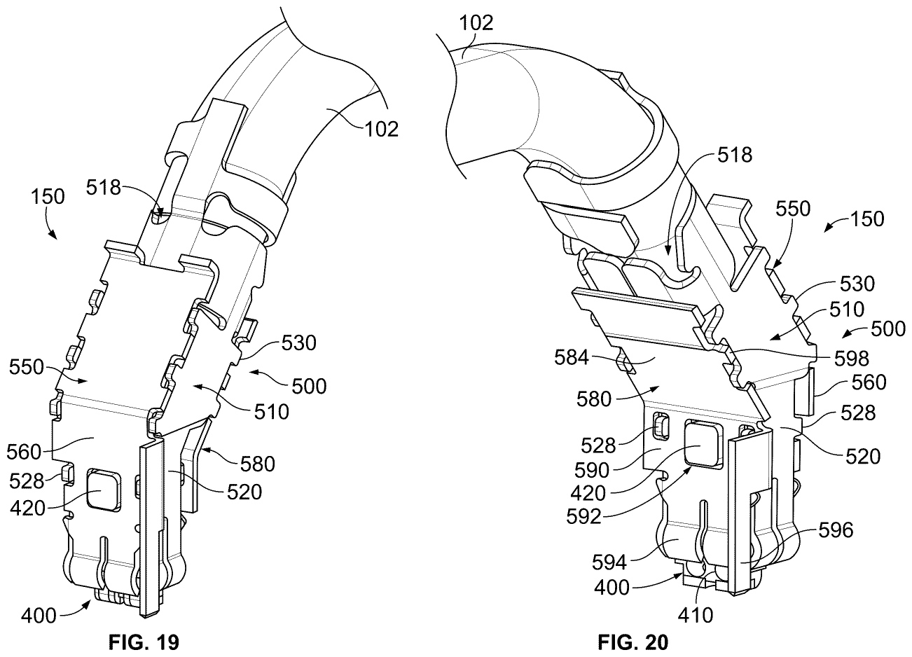

FIG. 19 is a front perspective view of the cable termination module 150 showing the rear cover 580 coupled to the ferrule 510 in accordance with an exemplary embodiment. FIG. 20 is a rear perspective view of the cable termination module 150 showing the rear cover 580 coupled to the ferrule 510 in accordance with an exemplary embodiment.

During assembly, the rear cover 580 is coupled to the rear of the ferrule 510. The rear cover 580 is electrically coupled to the ferrule 510. For example, the rear cover 580 may be welded or soldered to the ferrule 510. The rear cover 580 may cover a portion of the cradle 518. The rear cover 580 covers a portion of the contact module 400 to provide electrical shielding, such as along the rear of the contact module 400. Once assembled, the assembled cable termination module 150 is a testable component. For example, the cable termination module 150 may be plugged into a testing fixture to test the signal transmission and the grounding structure. Electrical characteristics of the cable termination module 150 may be tested, such as reliability, transmission speed, bandwidth, latency, signal integrity, shielding, cross talk, impedance, resistance to vibration/shock/temperature fluctuations, and the like.

The rear cover 580 is manufactured from a conductive material, such as a metal material. For example, the rear cover 580 may be manufactured from a copper or copper alloy material. In an exemplary embodiment, the conductive material is a phosphor bronze allow, such as CuSn8 containing approximately 8% tin. The conductive material may contain between 7%-9% tin. The conductive material may contain between 0.01%-0.35% phosphorus. The conductive material may contain less than 0.01% iron. The conductive material may contain less than 0.005% lead. The conductive material may contain less than 0.02% zinc. The conductive material may have a conductivity of greater than 5.0 m/Ω·mm² (9% IACS). The conductive material may have high strength characteristics, good wear resistance characteristics, good corrosion resistance characteristics, good spring properties. In an exemplary embodiment, the conductive material is configured to be solderable and configured to be weldable. In an exemplary embodiment, the rear cover 580 is a stamped and formed part. A plurality of the rear covers 580 may be stamped from a single metal sheet and connected by tie bars or other connecting structures.

The rear cover 580 includes a cover wall 584 configured to extend along the rear of the cable 102 and the corresponding ferrule 510 to cover the rear of the cable 102. The rear cover 580 may include additional walls in alternative embodiments, such as side walls configured to extend along sides of the cable 102.

In an exemplary embodiment, the rear cover 580 includes a shield wall 590 extending from the cover wall 584. In the illustrated embodiment, the shield wall 590 may extend downward from the rear of the cover wall 584. The shield wall 590 may extend at an angle relative to the cover wall 584. The shield wall 590 provides shielding along the rear of the contact module 400. In an exemplary embodiment, the shield wall 590 includes an opening 592. The opening 592 receives the securing feature 420 of the contact holder 410. The securing feature 420 may be heat staked to the rear cover 580.

The shield wall 590 is configured to be coupled to the ground block 300. For example, the shield wall 590 may include one or more ground beams 594. The ground beams 594 may extend downward at the bottom of the shield wall 590. The ground beams 594 may extend along the second side 418 (for example, rear) of the contact holder 410. The ground beams 594 may extend along the contacts 430 (for example, rearward of the contacts 430). In an exemplary embodiment, the ground beams 594 are aligned with the contacts 430, such as aligned with corresponding contacts 430. The ground beams 594 may be aligned with the ground beams 564 of the front cover 550 on opposite sides of the contact holder 410. The ground beams 564, 594 are located on opposite sides (front and rear) of the contacts 430. In an exemplary embodiment, the ground beams 564, 594 operate with the ground beams 540 of the ferrule 510 to provide shielding and ground mating interfaces to the ground block 300 on all sides of the contacts 430 to form a 360° picket fence type ground structure around the pair of the contacts 430.

In an exemplary embodiment, the ground beams 594 are deflectable and configured to be coupled to the ground block 300. For example, when the ground cage 500 is plugged into the ground block 300, the ground beams 594 may interface with the ground block 300 to deflect and electrically connect the ground cage 500 to the ground block 300. The ground beams 594 may include curved ends to form mating interfaces configured to directly engage the ground block 300. In the illustrated embodiment, multiple ground beams 594 are provided on each shield wall 590. The ground beams 594 extend parallel to each other. The ground beams 594 are separated by slots to allow the ground beams 594 to move independently. The ground beams 594 may be used as locating or alignment features to locate or align the cable termination module 150 in the pocket 320 of the ground block 300 (for example, for lateral or longitudinal positioning).

In various embodiments, the shield wall 590 may include one or more retention barbs (not shown) extending therefrom, such as from the side edges of the shield wall 590. The retention barbs may be press-fit into the pocket in the ground block 300 to create a mechanical and electrical connection to the ground block 300. The retention barbs may be press-fit into the pocket 320 in the ground block 300 to create a mechanical and electrical connection to the ground block 300. The retention barbs may be used as locating or alignment features to locate or align the cable termination module 150 in the pocket 320 of the ground block 300 (for example, for lateral or longitudinal positioning). In the illustrated embodiment, the shield wall 590 and the shield wall 560 includes openings that receive retention barbs 528 extending from the shield walls 520 of the ferrule 510. The retention barbs 528 pass through the shield walls 560, 590 of the front and rear covers 550, 580 to interface with the ground block 300.

In an exemplary embodiment, the rear cover 580 includes one or more locating or alignment features to locate or align the cable termination module 150 in the pocket 320 of the ground block 300 (for example, for lateral or longitudinal positioning). In an exemplary embodiment, the locating or alignment features include a connecting leg 596 extending from the shield wall 590 or the cover wall 584. The connecting leg 596 is configured to be plugged into the ground block 300, such as into the corresponding slot 330 in the ground block 300. The connecting leg 596 is configured to be mechanically and/or electrically connected to the ground block 300 in the slot 330. For example, the connecting leg 596 may be welded or soldered to the ground block 300, such as along the side(s), along the edge(s), and or at the distal end thereof. In other embodiments, the connecting leg 596 may be connected by an interference fit.

In an exemplary embodiment, the ferrule 510 includes connecting tabs 598 extending from the side edges of the cover wall 584 and/or the shield wall 590. The connecting tabs 598 are configured to be connected to the ferrule 510. For example, the connecting tabs 598 may be welded to the ferrule 510. The connecting tabs 598 may internest with the connecting tabs 530 to form welding surfaces or pockets. In the illustrated embodiment, the connecting tabs 598 are rectangular-shaped. However, the connecting tabs 598 may have other shapes in alternative embodiments.

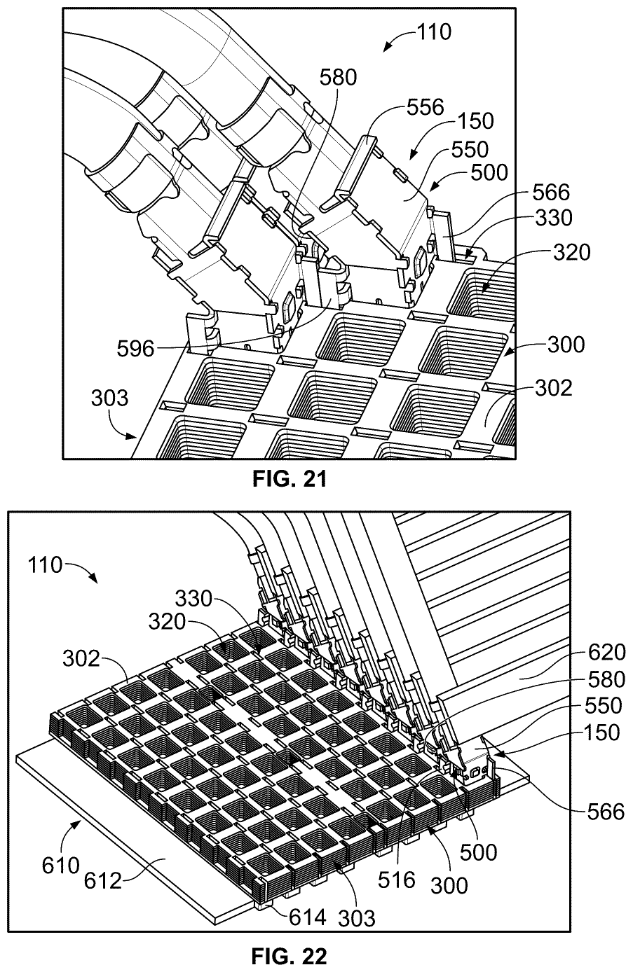

FIG. 21 illustrates a portion of the cable assembly 110 showing a plurality of the cable termination modules 150 loaded into the ground block 300 in accordance with an exemplary embodiment. FIG. 22 illustrates a portion of the cable assembly 110 showing a plurality of the cable termination modules 150 loaded into the ground block 300 in accordance with an exemplary embodiment. In an exemplary embodiment, each of the cable termination modules 150 are independently testable prior to assembly with the ground block 300 into the cable assembly 110. For example, electrical characteristics of the cable termination module 150 may be tested, such as reliability, transmission speed, bandwidth, latency, signal integrity, shielding, cross talk, impedance, resistance to vibration/shock/temperature fluctuations, and the like. The testing of the individual termination modules 150 prior to assembly improves manufacturing output and reduces product yield or rework.

During assembly, the cable termination modules 150 may be individually loaded into the corresponding pockets 320 of the ground block 300. For example, the cable termination modules 150 may be loaded into the pockets 320 from above. In an exemplary embodiment, an assembly tool 610 may be used to aid in assembly. The assembly tool 610 may be located below the ground block 300 and is used to align the components during assembly. For example, the assembly tool 610 may be used to position the ground block 300 and/or the cable termination modules 150 during assembly. In an exemplary embodiment, the assembly tool 610 includes a plate 612 and contact locators 614 held by the plate 612. The plate 612 is located below the ground block 300. The plate 612 may be used to provide a planar surface to support the plates 302 of the plate stack 303. The contact locators 614 may extend from the plate 612 into the pockets 320 to interface with and position the cable termination modules 150 during assembly. The contact locators 614 may hold X, Y, and Z positioning of the cable termination modules 150 during assembly. The contact locators 614 may hold all of the contacts 430 of the contact modules 400 coplanar within the ground block 300 during assembly. The cable termination modules 150 may be pressed into the ground block 300 until the cable termination modules 150 bottom out against the assembly tool 610. Other types of locating elements may be used for positioning the components relative to each other in one or more directions, including features that are part of the ground block 300 and/or the cable termination modules 150, rather than a separate tool or fixturing element.

In an exemplary embodiment, a pressing tool 620 is used to press the cable termination modules 150 into the pockets 320. The pressing tool 620 may press against the press tabs 556 of the front cover 550 to press the cable termination module 150 downward and load the ground cage 500 and contact module 400 into the pocket 320. During assembly, the connecting legs 566, 596 of the front and rear covers 550, 580 are loaded into the corresponding slots 330. In an exemplary embodiment, the first and second connecting legs 566, 596 are configured to be received in different slots 330 of the ground block 300. Optionally, the connecting legs 566, 596 of adjacent cable termination modules 150 may be received in the same slot 330 and connected to each other. For example, the connecting legs 566, 596 of the adjacent cable termination modules 150 may be welded together in the slot 330 while being welded to the ground block 300. For example, the welding may be laser welding or ultrasonic welding. In alternative embodiments, the connecting legs 566, 596 may be received in different slots 330.

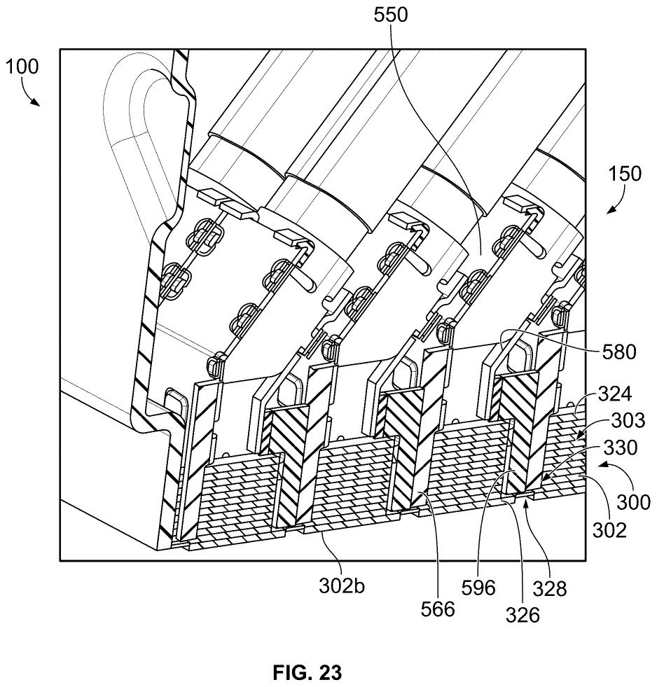

FIG. 23 is a cross-sectional view of a portion of the plug connector 100 showing a plurality of the cable termination modules 150 loaded into the ground block 300 in accordance with an exemplary embodiment. FIG. 23 shows the ground block 300 including a plurality of the plates 302 arranged in the plate stack 303. The ground block 300 provides circumferential (for example, 360°) shielding for the mating ends of the cable termination modules 150.

FIG. 23 shows the connecting legs 566, 596 of the front and rear covers 550, 580 of the cable termination modules 150 loaded into the corresponding slots 330 of the ground block 300. The positions of the connecting legs 566, 596 within the slots 330 may be controlled to control longitudinal positioning and/or lateral positioning and/or vertical positioning of the cable termination modules 150 relative to the ground block 300. Other alignment features of the cable termination modules 150 and/or the ground block 300 may be provided to control the longitudinal positioning and/or lateral positioning and/or vertical positioning. For example, the locating surfaces 326 of the bottom plate 302b may be used for controlling the vertical positioning. In an exemplary embodiment, the connecting legs 566, 596 may be welded to each other and/or to the plate(s) 302 of the ground block 300 to mechanically and electrically connect the cable termination modules 150 to the ground block 300. In an exemplary embodiment, one or more of the connecting legs 566, 596 may include retention barbs configured to interface with the plate(s) 302 of the ground block 300, such as by an interference fit. However, the connecting legs 566, 596 may be provided without retention barbs in other various embodiments.

In an exemplary embodiment, the bottom plate 302b includes the openings 328 aligned with the slots 330. The openings 328 have different sizes/shapes than the slots 330, such as to block pass through of the connection legs 566, 596 through the openings 328. The openings 328 are aligned with the slots 330 to access the connection legs 566, 596 and the rails 324 of the plate 302 surrounding the slots 330 from below through the openings 328 for welding.

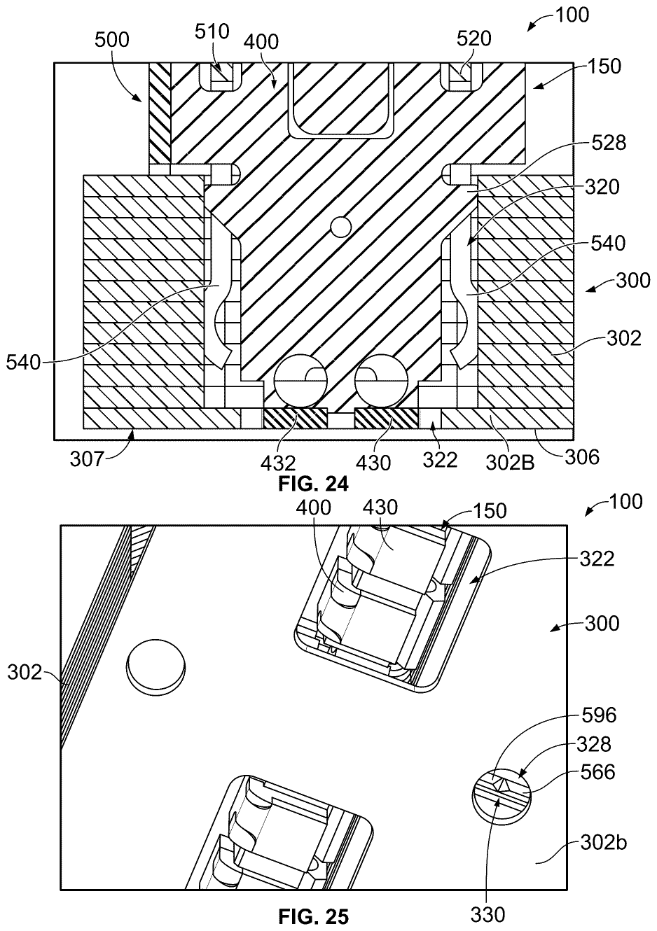

FIG. 24 is a cross-sectional view of a portion of the plug connector 100 showing one of the cable termination modules 150 loaded into the ground block 300 in accordance with an exemplary embodiment. During assembly, the cable termination module 150 is loaded into the pocket 320, such as from above. The shield walls of the ground cage 500 are received in the pocket 320.

In an exemplary embodiment, the ground beams 540, 564, 594 of the ground cage 500 are configured to be deflected and spring biased outward against the plates 302 to electrically connect the ground cage 500 to the ground block 300. The ground beams 540, 564, 594 provide points of contact with the ground block 300. The ground beams 540, 564, 594 may be aligned with the contacts 430, such as surrounding all four sides of the contacts 430. The ground beams 540, 564, 594 may be used as locating or alignment features to locate or align the cable termination module 150 in the pocket 320 of the ground block 300 (for example, for lateral or longitudinal positioning).

In an exemplary embodiment, the retention barbs 528 are configured to interface with the ground block 300, such as by an interference fit. The retention barbs 528 may be part of the ferrule 510 and/or the front cover 550 and/or the rear cover 580. The retention barbs 528 create a mechanical and/or electrical connection between the ground cage 500 and the ground block 300. The retention barbs 528 may be used as locating or alignment features to locate or align the cable termination module 150 in the pocket 320 of the ground block 300 (for example, for lateral or longitudinal positioning).

In an exemplary embodiment, when assembled, the contact module 400 is configured to pass through the pocket 320 to interface with the socket connector 200 (shown in FIG. 2). For example, the bottom end of the contact module 400 is exposed at the bottom 306 of the ground block 300 for mating with the socket connector 200. In an exemplary embodiment, the connecting ends 432 of the contacts 430 are coplanar with the lower surface 307 of the ground block 300 for interfacing with the socket connector 200. The lower surface 307 defines the mating interface configured to be mated with the socket connector 200. The lower surface 307 is configured to form a direct electrical path with the socket connector 200, such as with the ground socket contacts. In an exemplary embodiment, the bottom plate 302b is configured to be held planar to provide a planar mating interface with the socket connector 200. The connecting ends 432 of the contacts 430 are located in the bottom opening 322 of the bottom plate 302b such that the bottom surfaces of the contacts 430 are coplanar with the bottom surface of the ground block 300.

FIG. 25 is a bottom perspective view of a portion of the plug connector 100 showing the cable termination modules 150 in the ground block 300 in accordance with an exemplary embodiment. FIG. 25 shows the contacts 430 at the bottom of the contact module 400 located in the bottom opening 322 of the bottom plate 302b of the ground block 300. FIG. 25 shows the openings 328 in the bottom plate 302b aligned with the slots 330 in the corresponding connecting legs 566, 596 of the ground cages 500. The connecting legs 566, 596 may be welded to each other and/or to the plates 302 within the slot 330 and/or to the bottom plate 302b through the openings 328.

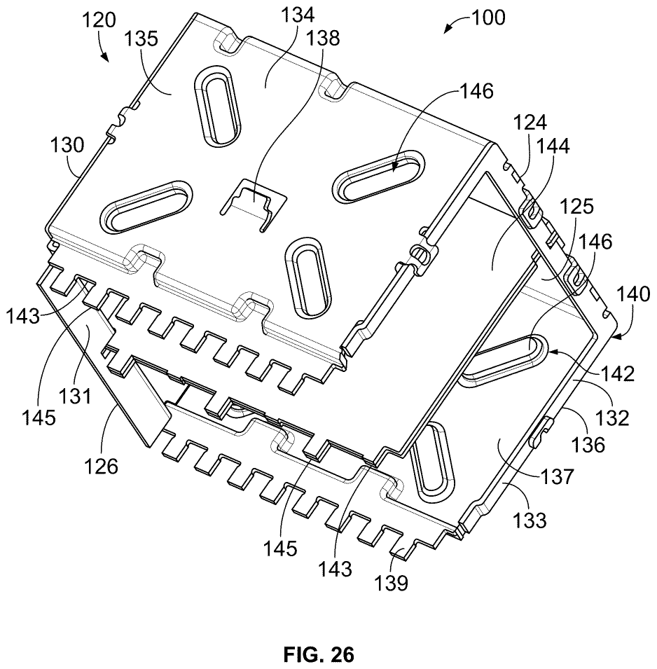

FIG. 26 is a bottom perceptive view of a portion of the connector housing 120 in accordance with an exemplary embodiment. FIG. 26 shows the outer plug shell 140. The outer plug shell 140 includes a plurality of walls forming the shell cavity 142. The shell cavity 142 is configured to receive the cable assembly 110 (FIG. 4). The shell cavity 142 may receive a portion of the cable strain relief element 122 (FIG. 3).

In an exemplary embodiment, the outer plug shell 140 includes a top wall 125 at the top 124, a front wall 131 at the front 130, a rear wall 133 at the rear 132, a first side wall 135 at the first side 134, and a second side wall 137 at the second side 136. The outer plug shell 140 may include a bottom wall at the bottom 126. The walls generally surround and define the shell cavity 142. The walls may include openings to allow access to the cable assembly 110, such as at the bottom 126 and/or the rear 132. In an exemplary embodiment, the walls are conductive to provide shielding around the shell cavity 142. For example, the walls may be stamped and formed walls. The walls may be manufactured by other processes in alternative embodiments, such as being molded (for example, cast, injection molded, etc.) and/or machined. In the illustrated embodiment, the outer plug shell 140 is generally rectangular in shape. The outer plug shell 140 may have other shapes in alternative embodiments and/or may include other walls to form a different shape.

One or more of the walls may be coupled to the cable assembly 110, such as to the ground block 300 to transfer mating forces during mating with the socket connector 200. For example, the front wall 131 and/or the first side wall 135 and/or the second side wall 137 and/or the rear wall 133 may be coupled to the ground block 300. One or more of the walls may be electrically coupled to the cable assembly 110, such as to the ground block 300. In an exemplary embodiment, one or more of the walls include upper shoulders 143 and/or the lower shoulders 145 configured to be coupled to the ground block 300. In an exemplary embodiment, one or more the walls include weld tabs 139 configured to be welded to the ground block 300.

In various embodiments, one or more of the walls may be formed integral with each other. For example, the first and second side walls 135, 137 may be integral with the top wall 125. Other walls may be integral with each other in alternative embodiments. In the illustrated embodiment, the first and second side walls 135, 137 include the latching elements 138 extending therefrom. Other walls may include the latching elements 138 in alternative embodiments.

In various embodiments, one or more of the walls may be separate and discrete from other walls and electrically connected thereto. For example, the front wall 131 and/or the rear wall 133 may be coupled to the top wall 125 and/or the first side wall 135 and/or the second side wall 137. In various embodiments, the walls may be welded together, such as being laser welded. The walls may be secured together by clips, crimp tabs, fasteners, latches, or other means. In an exemplary embodiment, the front wall 131 is separate from the other walls to allow access to the shell cavity 142, such as for filling the shell cavity 142 with epoxy, hot melt, or other dielectric material to form the cable strain relief element 122 in place in the shell cavity 142 after the cable assembly 110 is positioned in the shell cavity 142.

In an exemplary embodiment, the outer plug shell 140 includes an interior support wall 144 received in the shell cavity 142. The interior support wall 144 may be approximately centered between the first and second side walls 135, 137. In various embodiments, the interior support wall 144 may extend vertically (for example, between the top 124 and the bottom 126. The interior support wall 144 may extend longitudinally, such as between the front 130 and the rear 132. In the illustrated embodiment, the interior support wall 144 is coupled to the top wall 125 and/or the front wall 131. For example, the interior support wall 144 may be welded to the front wall 131 and/or the top wall 125. The interior support wall 144 may extend in other directions and/or between other walls in alternative embodiments. The interior support wall 144 may be coupled to the cable assembly 110, such as to the ground block 300 to transfer mating forces during mating with the socket connector 200. The interior support wall 144 may be electrically coupled to the cable assembly 110, such as to the ground block 300. In an exemplary embodiment, the interior support wall 144 includes upper shoulders 143 and/or the lower shoulders 145 configured to be coupled to the ground block 300.

In an exemplary embodiment, one or more of the walls of the outer plug shell 140 includes embossments 146 extending therefrom. For example, the first and second side walls 135, 137 may include embossments 146. The embossments 146 may protrude inwardly, such as into the shell cavity 142. Alternatively, the embossments 146 may protrude outwardly. The front wall 131 may additionally or alternatively include embossments 146. The interior support wall 144 may additionally or alternatively include embossments 146. The embossments 146 may increase the mechanical robustness or rigidity of the wall, such as to reduce bending or buckling, such as due to pressing forces during mating of the plug connector 100 with the socket connector 200.

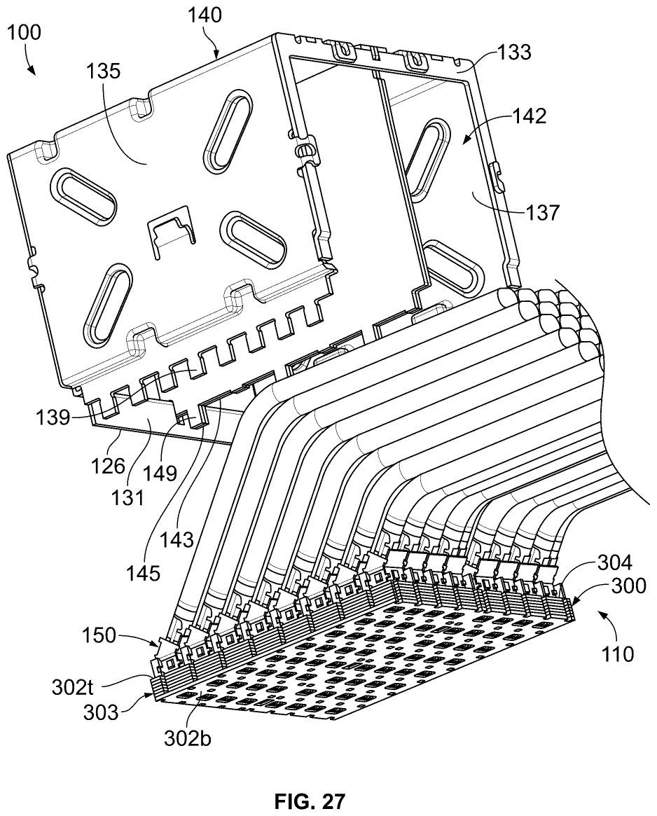

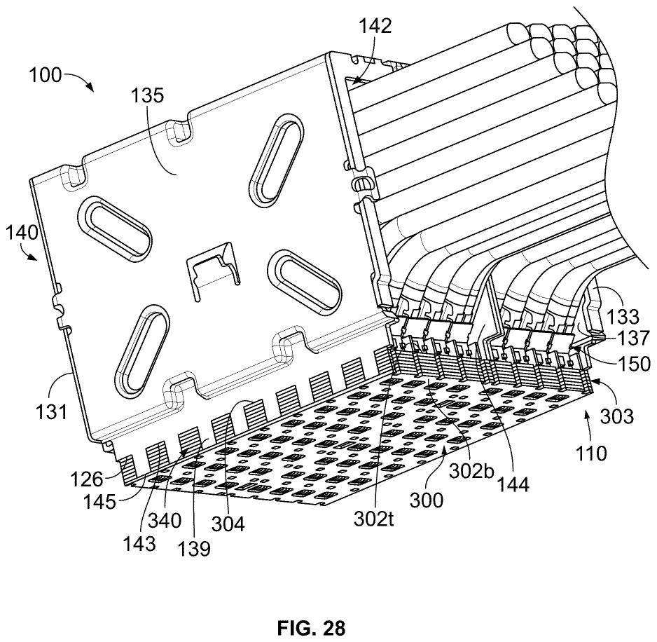

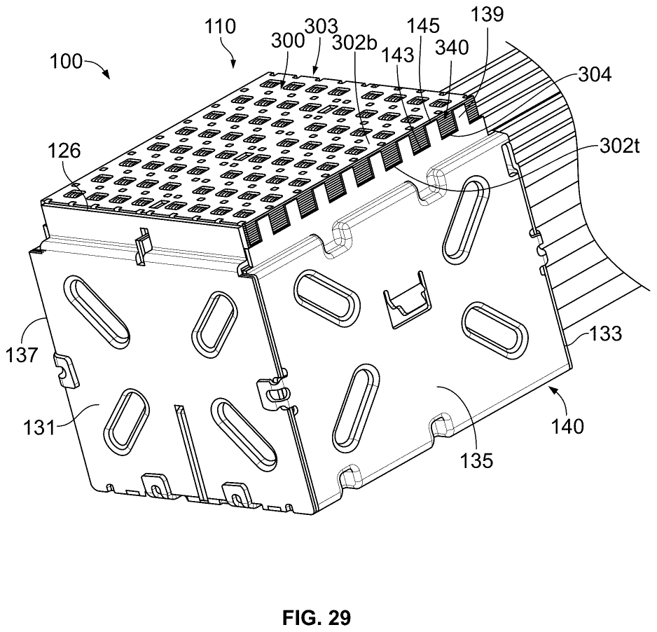

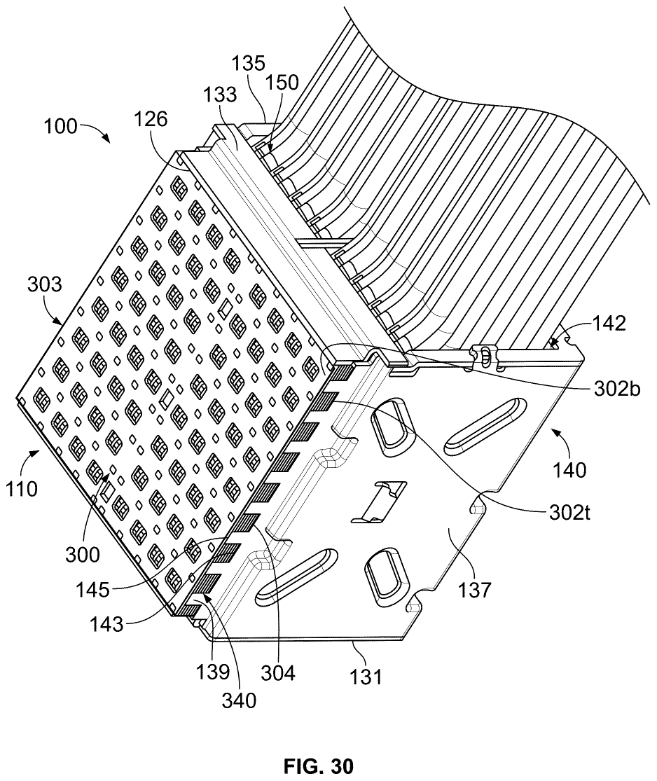

FIG. 27 is a bottom perspective view of a portion of the plug connector 100 showing the cable assembly 110 poised for loading into the shell cavity 142 of the outer plug shell 140. FIG. 28 is a bottom perspective view of a portion of the plug connector 100 showing the cable assembly 110 loaded into the shell cavity 142 of the outer plug shell 140. FIG. 29 is a front perspective view of a portion of the plug connector 100 showing the cable assembly 110 loaded into the shell cavity 142 of the outer plug shell 140. FIG. 30 is a rear perspective view of a portion of the plug connector 100 showing the cable assembly 110 loaded into the shell cavity 142 of the outer plug shell 140.

In an exemplary embodiment, the cable assembly 110 is loaded into the shell cavity 142 through the bottom 126. In an exemplary embodiment, the interior support wall 144 divides the shell cavity 142 into different cable chambers that receive different groups of the cable termination modules 150. The first and second side walls 135, 137 and the interior support wall 144 are configured to interface with different portions of the ground block 300, such as to evenly distribute downward mating forces from the outer plug shell 140 to the ground block 300 during mating with the socket connector 200.

During assembly, the first and second side walls 135, 137 are coupled to the ground block 300. For example, the weld tabs 139 may be received in corresponding wells 340 along the sides of the ground block 300. The weld tabs 139 may be welded to the ground block 300 to create mechanical and electrical connections between the first and second side walls 135, 137 and the ground block 300. In an exemplary embodiment, the upper shoulders 143 of the first and second side walls 135, 137 are configured to engage the top 304 of the ground block 300. For example, the upper shoulders 143 may be seated on the upper surface of the top plate 302t of the plate stack 303. In an exemplary embodiment, the lower shoulders 145 of the first and second side walls 135, 137 are configured to be coupled to the ground block 300. For example, the lower shoulders 145 may be defined by bottom edges of the weld tabs 139. The lower shoulders 145 may be seated on the upper surface at the bottom plate 302b to press the bottom plate 302b downward during mating.

During assembly, the interior support wall 144 is coupled to the ground block 300. For example, wall tabs 149 of the interior support wall 144 may be received in corresponding wells or openings of the ground block 300. The wall tabs 149 may be welded to the ground block 300 to create mechanical and electrical connections between the interior support wall 144 and the ground block 300. In an exemplary embodiment, the upper shoulders 143 of the interior support wall 144 are configured to engage the top 304 of the ground block 300. For example, the upper shoulders 143 may be seated on the upper surface of the top plate 302t of the plate stack 303. In an exemplary embodiment, the lower shoulders 145 of the interior support wall 144 are configured to be coupled to the ground block 300. For example, the lower shoulders 145 may be defined by bottom edges of the wall tabs 149. The lower shoulders 145 may be seated on the upper surface at the bottom plate 302b to press the bottom plate 302b downward during mating.

During assembly, the front wall 131 (FIG. 29) may be coupled to the ground block 300. For example, the front wall 131 may be welded to the front of the ground block 300. In various embodiments, the front wall 131 may include weld tabs (not shown) received in corresponding wells in the ground block 300.

During assembly, the rear wall 133 (FIG. 30) may be coupled to the ground block 300. For example, the rear wall 133 may be welded to the front of the ground block 300. In various embodiments, the rear wall 133 is may include weld tabs (not shown) received in corresponding wells in the ground block 300.

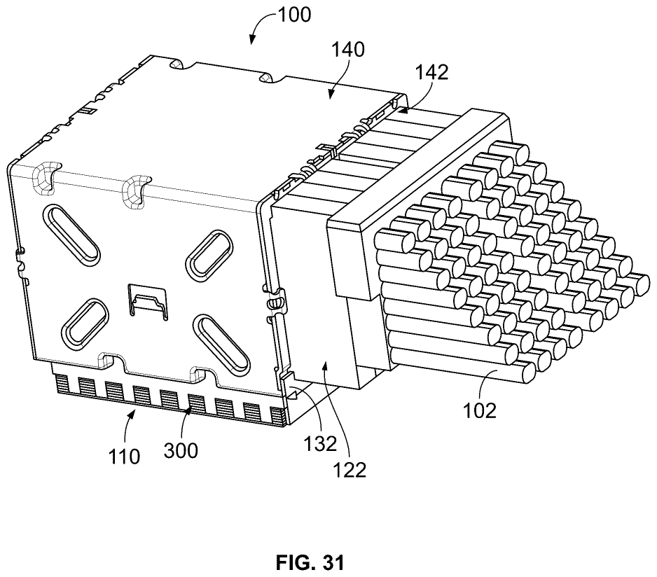

FIG. 31 is a top perspective view of a portion of the plug connector 100 showing the cable assembly 110 and the cable strain relief element 122 coupled to the outer plug shell 140. In an exemplary embodiment, the cable strain relief element 122 is coupled to the cables 102 of the cable assembly 110. The cable strain relief element 122 provides strain relief for the cables 102. The cable strain relief element 122 may hold portions of the cable termination modules 150, such as to fix positions of the cable termination modules 150 relative to the ground block 300 to prevent movement of the cable termination modules 150 relative to the ground block 300 and the socket connector 200 to improve signal integrity and electrical performance.

In an exemplary embodiment, the cable strain relief element 122 extends from the outer plug shell 140. For example, the cable strain relief element 122 may extend rearwardly from the rear 132. The cable strain relief element 122 covers portions of the cables 102 as the cables 102 exit the outer plug shell 140. In various embodiments, the cable strain relief element 122 may be formed in place around the cables 102 and/or the cable termination modules 150 after the cable assembly 110 is received in the shell cavity 142 of the outer plug shell 140. For example, the cable strain relief element 122 may be injection molded, insert molded or formed by filling the shell cavity 142 with support material that is cured or otherwise hardened to form the cable strain relief element 122. The cable strain relief element 122 may fill the gaps or spaces between the cables 102 and the cable termination modules 150 from neighboring cables 102 and cable termination modules 150. In alternative embodiments, the cable strain relief element 122 may be formed separate from the outer plug shell 140. For example, the cable strain relief element 122 may be preformed and coupled to the cables 102 and the cable termination modules 150 prior to loading the cable assembly 110 into the outer plug shell 140.

In an exemplary embodiment, the cable strain relief 122 may be overmolded over a portion of the outer plug shell 140, such as the rear wall 133 to fix the cable strain relief 122 to the outer plug shell 140. Optionally, the rear wall 133 may include fingers, tabs, or other extensions that extend between the cables 102 to organize the cables 102 and hold relative positions of the cables 102 prior to overmolding of the cables 102 with the cable strain relief material. For example, U-shaped troughs or channels may extend from the rear wall 133 to hold individual columns of the cables for proper spacing of the cables 102 to allow the material of the cable strain relief 122 to flow between the columns of the cables 102.

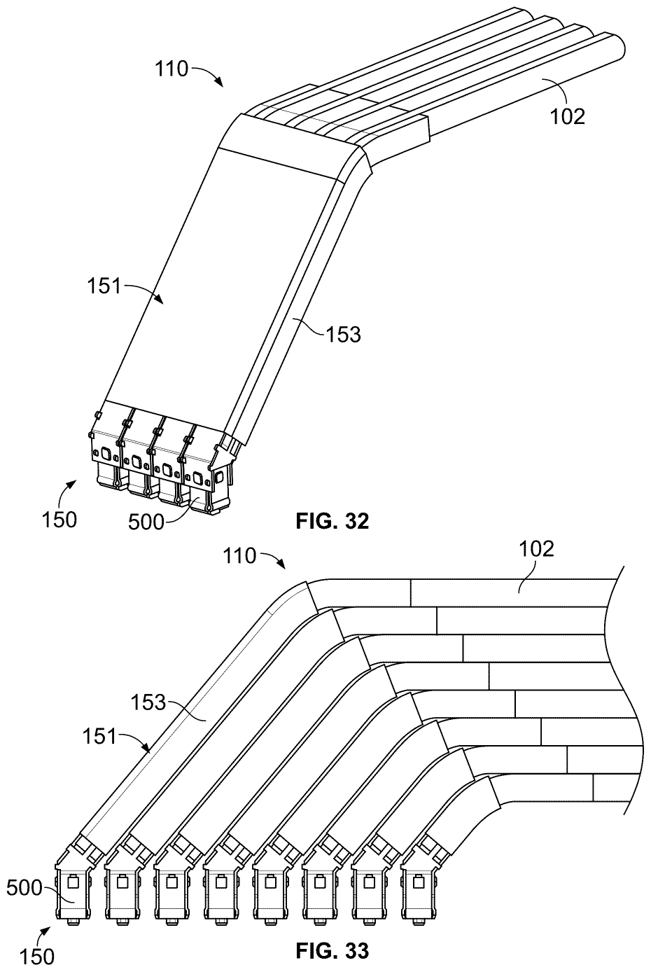

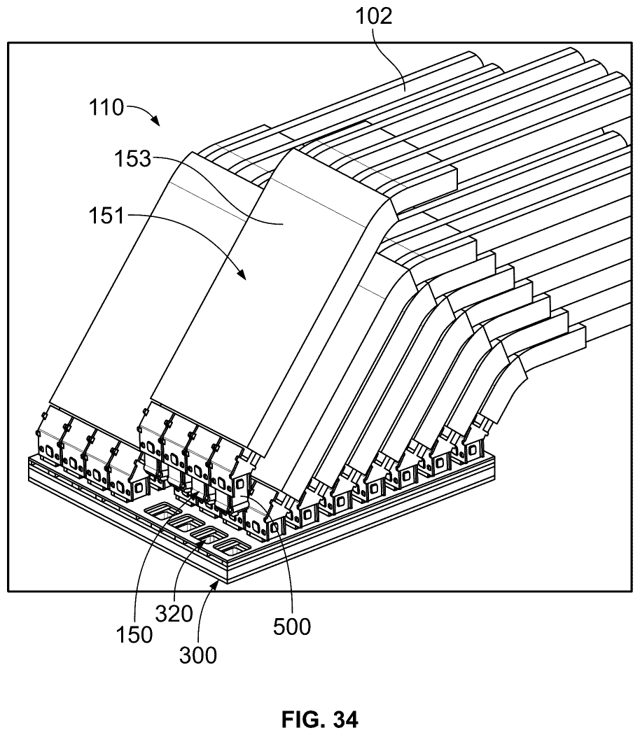

FIG. 32 is a perspective view of a group of cable termination modules 150 that are integrated into a common cable termination module 151. FIG. 33 is a side view of a plurality of the common cable termination modules 151. FIG. 34 is a perspective view of the cable assembly 110 in accordance with an exemplary embodiment showing a plurality of the common cable termination modules 151 coupled to the ground block 300. In the illustrated embodiment, four of the cable termination modules 150 are grouped together to form each of the common cable termination modules 151. Greater or fewer of the cable termination modules 150 may be grouped together to form the common cable termination modules 151 in alternative embodiments. In the illustrated embodiment, the grouped cable termination modules 150 are arranged together in a single row (for example, a 1×4 array, 1×8 array, etc.); however, the cable termination modules 150 may be arranged together in multiple rows (for example, a 2×2, 2×4, 4×4, etc.).

In an exemplary embodiment, the common cable termination module 151 includes a module holder 153 and holds the cable termination modules 150 together in a group. In various embodiments, the module holder 153 includes a dielectric body, such as an overmold body that is overmolded over portions of the cable termination modules 150 and/or the cables 102. In alternative embodiments, the module holder 153 may be conductive, such as a stamped and formed metal frame, that is coupled to the ground cages 500 of the cable termination modules 150. The module holder 153 may be manufactured by other processes in alternative embodiments, such as being molded (for example, cast, injection molded, etc.) and/or machined. The group of the cable termination modules 150 may be loaded into the corresponding pockets 320 in the ground block 300 as a unit.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A plug connector for mating with an electrical connector, the plug connector comprising:
cable termination modules, each cable termination module including a contact module having contacts extending between connecting ends configured to be mated with mating contacts of the electrical connector and terminating ends opposite the connecting ends, each cable termination module including cables having signal conductors terminated to the terminating ends of the corresponding contacts and a cable shield surrounding the signal conductors, each cable termination module including a ground cage providing circumferential shielding around an end of the cable and around the corresponding contact module, the ground cage including one or more connecting legs at a mating end of the ground cage; and
a ground block including pockets receiving the corresponding cable termination modules, the ground block being electrically conductive and providing shielding around the pockets for shielding the cable termination modules, the ground block being electrically connected to the ground cages, the ground block organizing the cable termination modules relative to each other and positioning the cable termination modules for mating, the ground block including slots proximate to the pockets, the slots receiving the connecting legs of the ground cages of the cable termination modules;
wherein the connecting legs are mechanically connected to the ground block in the corresponding slots.

2. The plug connector of claim 1, wherein the connecting legs are welded to the ground block within the slots.

3. The plug connector of claim 1, wherein the connecting legs extend to distal ends, the distal ends of the connecting legs being welded to the ground block.

4. The plug connector of claim 1, wherein the ground cage includes a front cover and a rear cover, the connecting leg being a first connecting leg extending from the front cover, the rear cover including a second connecting leg received in the corresponding slot of the ground block.

5. The plug connector of claim 4, wherein the first and second connecting legs are received in different slots of the ground block.

6. The plug connector of claim 4, wherein the first and second connecting legs are received in different slots with second and first connecting legs, respectively, of different cable termination modules.

7. The plug connector of claim 1, wherein the ground cage includes retention barbs, the retention barbs being received in the corresponding pocket, the retention barbs being mechanically connected to the ground block.

8. The plug connector of claim 1, wherein the ground block includes a plurality of plates arranged in a plate stack, the plates including openings aligned in the plate stack to form the pockets, wherein the ground cages are electrically connected to at least one of the plates in the plate stack to electrically connect the ground block to the ground cages.

9. The plug connector of claim 8, wherein the plates in the plate stack include a top plate, a bottom plate, and inner plates between the top and bottom plates, the connecting leg being welded to at least one of the inner plates at a weld location remote from the bottom plate.

10. The plug connector of claim 1, wherein the ground block has a thickness, the pockets having a lateral width and a longitudinal width across the pockets, the lateral width and the longitudinal width being dimensions within 10% of the thickness of the ground block.

11. The plug connector of claim 1, wherein the ground block has a thickness of approximately 1.2 mm, the pockets having a lateral width of approximately 1.3 mm, the pockets having a longitudinal width of approximately 1.0 mm.

12. The plug connector of claim 1, wherein the ground block provides electrical shielding between each of the cable termination modules.

13. The plug connector of claim 1, wherein the ground block is configured to be directly mated to ground contacts of the electrical connector.

14. The plug connector of claim 1, wherein the pockets are arranged in rows and columns to position the cable termination modules in rows and columns.

15. The plug connector of claim 1, wherein the cable termination modules are individually loaded into the pockets, the ground cages of the cable termination modules being independently coupled to the ground block, wherein the ground block electrically commons all of the ground cages of the cable termination modules.

16. A cable termination module for a plug connector comprising:
a contact module having contacts extending between connecting ends and terminating ends opposite the connecting ends;
a cable having signal conductors terminated to the terminating ends of the corresponding contacts and a cable shield surrounding the signal conductors; and
a ground cage providing circumferential shielding around an end of the cable and around the corresponding contact module, a mating end of the ground cage configured to be plugged into a pocket of a ground block at a bottom of the plug connector to electrically connect the ground cage to the ground block, the ground cage including a ferrule, a front cover coupled to the ferrule, and a rear cover coupled to the ferrule, the ferrule including a base wall, a first side wall extending from a first side of the base wall, and a second side wall extending from a second side of the base wall, the base wall, the first side wall, and the second side wall forming a cradle receiving the end of the cable, the first side wall covering a first side of the contact module, the second side wall covering a second side of the contact module, the front cover coupled to the first and second side walls to cover a front side of the contact module, the rear cover coupled to the first and second side walls to cover a rear side of the contact module, the ground cage including a connecting leg at a mating end of the ground cage configured to be plugged into the ground block to electrically connect the ground cage to the ground block.

17. The cable termination module of claim 16, wherein the connecting leg is a front connecting leg extending from the front cover, the ground cage including a rear connecting leg extending from the rear cover.

18. The cable termination module of claim 16, wherein the connecting leg includes a welding edge configured to be welded to the ground block.

19. The cable termination module of claim 16, wherein at least one of the first side wall, the second side wall, the front cover and the rear cover includes a retention barb configured to be plugged into the pocket of the ground block to mechanically and electrically connect the ground cage to the ground block.

20. A communication system comprising:
an electrical connector including a housing holding mating contacts, the mating contacts including mating interfaces, the mating contacts including signal contacts and ground contacts; and a plug connector configured to be coupled to the electrical connector, the plug connector including cable termination modules and a ground block including pockets receiving the corresponding cable termination modules;
each cable termination module including a contact module having contacts extending between connecting ends configured to be mated with the mating contacts of the electrical connector and terminating ends opposite the connecting ends, each cable termination module including cables having signal conductors terminated to the terminating ends of the corresponding contacts and a cable shield surrounding the signal conductors, each cable termination module including a ground cage providing circumferential shielding around an end of the cable and around the corresponding contact module, the ground cage including an connecting leg at a mating end of the ground cage; and
wherein the ground block is electrically conductive and provides shielding around the pockets for shielding the cable termination modules, the ground block being electrically connected to the ground cages, the ground block organizing the cable termination modules relative to each other and positioning the cable termination modules for mating with the electrical connector, the ground block including slots proximate to the pockets, the slots receiving the connecting legs of the ground cages of the cable termination modules, wherein the connecting legs are electrically connected to the ground block in the corresponding slots.
